(19) United States
(12) Patent Application Publication
(10) Pub. No.: US 2026/0361427 A1
(43) Pub. Date: Nov. 12, 2026

(54) PERIODIC LINK CALIBRATION IN ETHERNET INTERFACES

(71) Applicant: Cisco Technology, Inc., San Jose, CA (US)

(72) Inventors: Raafat Francis, Fassuta Village (IL); Aviran Kadosh, Moreshet (IL); Naor Goldman, Tzur Moshe (IL); Shai Erez, Tzofit (IL); Liran Brecher, Kefar Sava (IL); Thomas Helmut Toifl, Gattikon (CH); Shira Rozenberg, Ramat Gan (IL); Rui Peng, Shanghai (CN); Mor Levi, Gan Yavne (IL); Moty Mordechai Mor, Zikhron Yaakov (IL)

(21) Appl. No.: 19/204,405

(22) Filed: May 9, 2025

(51) Int. Cl. H04B 17/21; H04L 12/12

(52) U.S. Cl. CPC H04B 17/21; H04L 12/12

(57) ABSTRACT

Devices, systems, methods, and processes for periodic link calibration in an Ethernet interface are described herein. A transmitting network device includes a transmission circuitry communicatively coupled to a receiving network device. A power management logic, at the transmitting network device, generates a calibration sequence and transmits the calibration sequence via the transmission circuitry to the receiving network device. The calibration sequence comprises a calibration identifier and calibration data, and the calibration identifier precedes the calibration data in the calibration sequence. The receiving network device receives an input sequence comprising a transmission identifier and data. A power management logic at the receiving network device identifies the input sequence as calibration sequence or a payload sequence based on the transmission identifier corresponding to a calibration identifier or a data identifier, respectively. Based on the transmission identifier corresponding to calibration identifier, a receiving circuitry of the receiving network device is calibrated.

The present disclosure relates to wireless communication. More particularly, the present disclosure relates to periodic link calibration in an Ethernet interface.

### BACKGROUND

High-speed communication systems, such as Ethernet interfaces, employ burst mode transmission, where data is transmitted in short, intermittent bursts rather than as a continuous stream. In burst mode operation, transmitters activate only during data transmission, enabling the communication systems to conserve power and optimize bandwidth usage. While burst mode operation provides efficiency benefits, it presents challenges for traditional link calibration technique, which are based on steady-state, continuous data transmission, and rely on long training sequences to establish and maintain link integrity. Thus, the applicability of the traditional link calibration techniques may be limited in burst mode operation due to the dynamic nature of the link and shorter time periods available for calibration.

Additionally, in burst mode operation, abrupt switching between calibration and payload transmission can lead to service interruptions. For example, without a controlled transition between calibration and payload transmission, receiver can misinterpret training sequence as payload data or fail to detect when payload transmission resumes, resulting in decoding errors or dropped packets. Further, in some communication systems, delays may be introduced to allow calibration to complete before payload data is processed. However, such delays can increase latency and reduce overall link efficiency, especially in time-sensitive applications.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a networking environment in accordance with various embodiments of the disclosure;

FIG. 2 is a conceptual depiction of a communication layer architecture in accordance with various embodiments of the disclosure;

FIG. 3 is a conceptual diagram that illustrates a connection between two network devices in accordance with various embodiments of the disclosure;

FIG. 4 is a conceptual diagram that illustrates a data transmission sequence in accordance with various embodiments of the disclosure;

FIG. 5 is a conceptual timing diagram that illustrates flow of data via a communication link over a period of time in accordance with various embodiments of the disclosure;

FIGS. 6A, 6B, and 6C are timing diagrams depicting switching scenarios between calibration sequences and payload sequences in accordance with various embodiments of the disclosure;

FIG. 7 is a conceptual diagram of timing control management in an Ethernet interface in accordance with various embodiments of the disclosure;

FIG. 8 is a flowchart depicting a process for calibrating a receiving network device in accordance with various embodiments of the disclosure;

FIG. 9 is a flowchart depicting a process for performing periodic calibration in accordance with various embodiments of the disclosure;

FIG. 10 is a flowchart depicting a process for calibrating a receiving network device in accordance with various embodiments of the disclosure;

FIG. 11 is a flowchart depicting a process for power state transition in a receiving network device in accordance with various embodiments of the disclosure;

FIG. 12 is a flowchart depicting a process for assigning delays in accordance with various embodiments of the disclosure; and

FIG. 13 is a conceptual block diagram of a device suitable for configuration with a power management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DESCRIPTION OF EXAMPLE EMBODIMENTS

### Overview

In many embodiments, A method at a transmitting network device comprises generating a calibration sequence, wherein the calibration sequence includes a calibration identifier that precedes calibration data, and transmitting the calibration sequence to a receiving network device at a periodic time instance of a plurality of periodic time instances.

A receiving network device includes receiving circuitry communicatively coupled to a transmitting network device over a communication link, and a power management logic coupled to the receiving circuitry. This power management logic can be configured to receive an input sequence (which comprises a transmission identifier followed by data) over the communication link and to identify whether the received input sequence is a calibration sequence or a payload sequence based on its transmission identifier.

### Example Embodiments

In response to the issues described above, devices and methods are discussed herein that can facilitate power control management at Ethernet interfaces. An Ethernet interface is a physical and logical connection that enables a device (e.g., a computer, a switch, a router, a server, or the like) to communicate over an Ethernet network. Ethernet interface may include a communication port comprising hardware and software components that handle data transmission, reception, error detection, encoding/decoding, and/or flow control according to Ethernet standards. In an example, the communication port may be equipped with transmission circuitry that performs transmission of data over the network. In more examples, the communication port may be equipped with receiving circuitry that performs reception of data over the network. In yet more examples, the communication port may be equipped with transmission circuitry and receiving circuitry for performing transmission and reception of data over the network. Each transmission circuitry (and/or receiving circuitry) may further include a Serializer/deserializer (SerDes) circuit, along with additional components for data transmission (and/or reception). In yet various embodiments, the network device may include multiple such communication ports (e.g., a plurality of communication ports).

In many scenarios, Ethernet interfaces utilize burst mode transmission, where data is transmitted in discrete, non-continuous bursts rather than as a steady stream. Burst mode transmission may optimize power and bandwidth usage by activating transmission circuitry only during data transmission. To maintain reliable communication and compensate for channel impairments, device mismatches or variations in signal strength and timing, calibration may be performed. For example, calibration may involve adjusting various receiver parameters (such as gain, equalization, and clock alignment) to enhance receiver performance. Without calibration, high-speed or burst mode links may experience increased error rates, reduced throughput, or unstable connections.

However, the non-continuous and dynamic nature of burst mode transmission may present numerous challenges for conventional calibration techniques. Conventional calibration techniques usually rely on extended training sequences and assume a stable link environment, which makes them less effective for burst mode transmission. Moreover, without a controlled transition between calibration and payload transmission, a receiver can misinterpret training sequence as payload data or fail to detect when payload transmission resumes, resulting in decoding errors or dropped packets. Further, if delays are introduced to allow calibration to complete before payload data is processed, overall latency may increase and link efficiency may reduce.

Therefore, to coordinate calibration and payload sequences and ensure uninterrupted, reliable communication over the Ethernet interface, the present disclosure provides a solution based on periodic link calibration for burst mode links. In other words, the present disclosure provides a transmitting network device configured to perform periodic link calibration and to efficiently and rapidly switch between calibration and payload sequences, while also managing idle power usage. The transmitting network device may include a transmission circuitry (e.g., communication interface) that enters a low power state when idle, shutting down one or more unused circuits of the transmission circuitry while maintaining functionality for quick wake-up. In an example, the transmitting network device may include multiple communication interfaces that can enter the low power state when idle. As a result, the transmitting network device may operate in a green mode, reducing power consumption when the Ethernet interface is not functioning at its full capacity. In an example, the transmitting network device may be any transmitting component that utilizes the Ethernet interface for data transmission. The transmitting network device may be communicatively coupled to a receiving network device (e.g., a receiver) via a communication link. In further examples, the receiving network device may be any receiving component that uses an Ethernet interface for data reception.

In additional embodiments, the transmission circuitry may be configured to process and transmit payload data to the receiving network device. Similarly, the receiving network device may include a receiving circuitry (e.g., a communication interface) configured to receive and process the payload data transmitted by the transmission circuitry. In various aspects, the receiving circuitry may include a digital section and an analog section. Periodic link calibration may include calibration of the digital section and/or the analog section of the receiving circuitry. The transmitting network device may include a power management logic that is configured to execute the periodic link calibration, for example, before or after payload data transmission. The power management logic may be equipped inside the transmitting network device or externally coupled to the transmitting network device, for example, through a cloud-based server.

In a variety of embodiments, the power management logic may generate a calibration sequence. The calibration sequence may refer to a signal pattern for adjusting and synchronizing the receiving circuitry or one or more link parameters of a communication link that couples the transmission circuitry with the receiving circuitry. In numerous embodiments, the calibration sequence may include a calibration identifier and calibration data. The calibration identifier may precede the calibration data in the calibration sequence. The power management logic may be configured to transmit the calibration sequence via the transmission circuitry to the receiving network device (e.g., to the receiving circuitry). In a number of embodiments, the calibration of the receiving circuitry may occur periodically, for example, at a plurality of periodic time instances. In other words, the power management logic may be configured to transmit the calibration sequence, via the transmission circuitry, at a periodic time instance of the plurality of periodic time instances.

In yet various aspects, the calibration sequence may be configured for digital calibration or analog calibration at the receiving circuitry. In case the calibration sequence is configured for digital calibration (e.g., to calibrate the digital section of the receiving circuitry), the calibration sequence may be preceded by the calibration identifier which includes one or more first identifier bits. In other words, the calibration identifier including the one or more first identifier bits may indicate that the calibration sequence is intended for calibrating the digital section of the receiving circuitry. In more aspects, the calibration sequence with the one or more first identifier bits may act as a beacon which communicates to the receiving network device that the communication link is active and alive. In case the calibration sequence is configured for analog calibration (e.g., to calibrate the analog section of the receiving circuitry), the calibration sequence may be preceded by the calibration identifier which includes one or more second identifier bits different from the one or more first identifier bits. In other words, the calibration identifier including the one or more second identifier bits may indicate that the calibration sequence is intended for calibrating the analog section of the receiving network device.

In more embodiments, in case a periodic time instance of the plurality of periodic time instances for calibration occurs amidst an ongoing data transmission by the transmission circuitry, the power management logic may be configured to delay the periodic time instance. Based on the delayed periodic time instance, the power management logic may be configured to transmit the calibration sequence after the ongoing data transmission is complete.

In still more embodiments, the power management logic may receive a data transmission request during the transmission of the calibration sequence. The power management logic may transmit, via the transmission circuitry, an indication to specify an end of the calibration sequence in response to receiving the data transmission request. The power management logic may then transmit a payload sequence associated with the data transmission request after the indication. The payload sequence may refer to a portion of data transmission that carries actual user or application data, excluding overhead, control, or calibration data. The payload sequence may further include a data identifier and payload data. The data identifier may precede the payload data in the payload sequence. The data identifier may be configured to differentiate the payload data from the calibration data. The data identifier may include one or more third identifier bits that may be different from the one or more first identifier bits or the one or more second identifier bits.

In yet more embodiments, if the transmission circuitry is undergoing a power state transition (for example, from the power-down state to the power-up state or from the power-down state to the power-up state), the power management logic may be configured to transmit a preamble sequence before transmitting the calibration sequence or the payload sequence. Accordingly, the power management logic may be configured to generate the preamble sequence and transmit the preamble sequence via the transmission circuitry to the receiving network device. The preamble sequence may be configured to wake the receiving circuitry from the power-down state to the power-up state. In an example, the transmission of the preamble sequence may precede the transmission of the calibration sequence. The preamble sequence may include a Clock and Data Recovery (CDR) lock pattern and at least one start identifier bit. The CDR lock pattern may refer to a clock pattern configured to synchronize an internal clock of the receiving network device with incoming data (e.g., the calibration sequence or the payload sequence) for accurate sampling and decoding of subsequent bits. Meanwhile, the start identifier bit may correspond to a reference bit that signals a boundary between the preamble sequence and the incoming data (e.g., the calibration sequence or the payload sequence), allowing the receiving circuitry to reliably detect the beginning of the incoming data.

In several embodiments, the receiving network device may also include a power management logic configured to execute power control management during data reception. The power management logic may be equipped inside the receiving network device or externally coupled to the receiving network device, for example, through a cloud-based server. The power control management may be configured to receive an input sequence over the communication link from the transmitting network device. The input sequence may include a transmission identifier and data. The transmission identifier may be configured to precede the data. The power management logic may be configured to identify the received input sequence as one of a calibration sequence or a payload sequence based on the transmission identifier.

In further additional embodiments, the power management logic may be further configured to identify the received input sequence as the calibration sequence based on the transmission identifier corresponding to one of the one or more first identifier bits or the one or more second identifier bits. Accordingly, the power management logic may calibrate the receiving circuitry based on the identification of the received input sequence as the calibration sequence. In an example, the power management logic may calibrate the digital section of the receiving circuitry based on the identification of the received input sequence as the calibration sequence and the transmission identifier corresponding to the one or more first identifier bits. In further examples, the power management logic may calibrate the analog section based on the identification of the received input sequence as the calibration sequence and the transmission identifier corresponding to the one or more second identifier bits. On the contrary, the power management logic may identify the received input sequence as the payload sequence based on the transmission identifier corresponding to one or more third identifier bits and thus, process the payload sequence.

Thus, by performing periodic link calibration in an Ethernet interface, the systems, devices, and methods discussed herein may ensure that the communication link may continuously adapt to changing conditions such as temperature shifts, aging components, or signal drift for maintaining optimal performance and minimizing error rates. The systems, devices, and methods discussed herein may also enable fast and seamless switching between calibration and payload sequences to reduce latency, preventing data loss, and enabling more efficient use of bandwidth. In other words, periodic link calibration and rapid transition between different data sequences may enhance link reliability, improve real-time responsiveness, and support robust communication in dynamic or time-sensitive environments.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electrical current. In many additional embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

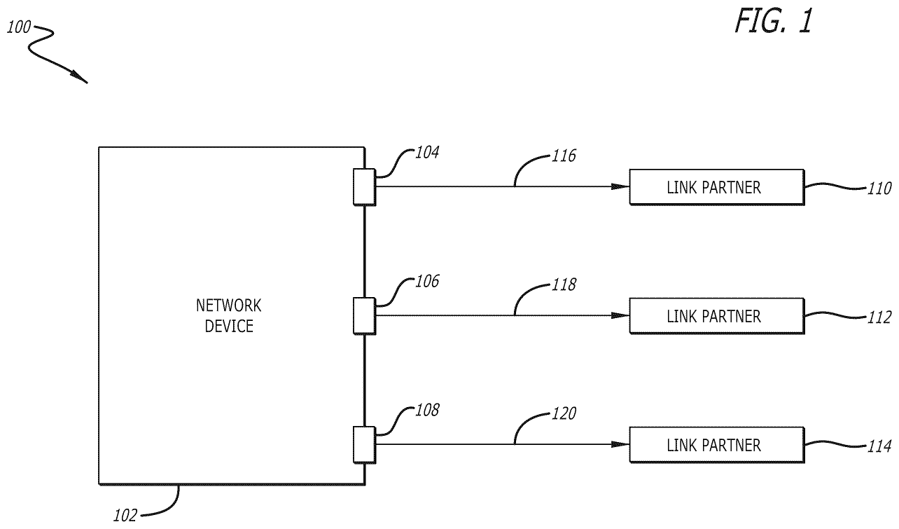

Referring to FIG. 1, a schematic block diagram of a networking environment 100 in accordance with various embodiments of the disclosure is shown. The embodiments depicted in FIG. 1 may show the networking environment 100 which can correspond to a network or a portion of the network. In many embodiments, the networking environment 100 may include a network device 102. The network device 102 may include hardware and/or software components that facilitate communication and transmission of data between computers or other network-enabled devices. In a network, the network device 102 may contribute to establishing and maintaining connections. Examples of the network device 102 may include a router, a switch, a hub, a modem, an access point, a server, a computing node, or the like. The network device 102 may include various ports that facilitate network connectivity. In a number of embodiments, the network device 102 may include a plurality of ports, of which ports 104-108 are shown. In a variety of embodiments, the ports 104-108 may correspond to communication ports of an Ethernet interface or simply Ethernet ports.

In more embodiments, the networking environment 100 may include a plurality of link partners associated with the network device 102, for example, via the ports 104 108. A link partner can correspond to a network device that couples to another network device via a network link. The network link may be a communication pathway that can couple two or more network devices, enabling data transmission between the network devices. In additional embodiments, the plurality of link partners may include link partners 110-114 associated with the ports 104-108, respectively. Examples of the link partners 110-114 may include Wireless Local Area Network (LAN) Controllers (WLCs), switches, access points, servers, modems, routers, Voice over Internet protocol (VoIP) devices, or the like.

As illustrated in FIG. 1, the link partner 110 may be coupled to the port 104 of the network device 102 by way of a link 116. Similarly, the link partner 112 may be coupled to the port 106 of the network device 102 by way of a link 118. Further, the link partner 114 may be coupled to the port 108 of the network device 102 by way of a link 120. In further embodiments, each link partner may include a port to facilitate coupling to a port of the network device. The network device 102 may, therefore, communicate with the link partners 110-114 by way of the links 116-120, respectively.

Traditionally, network devices have placed less emphasis on considering various aspects of operation that can relate to sustainability. To enhance sustainability, it may be beneficial to limit energy consumption, for example, by enabling the ports 104 108 to transition to a low power state when idle and resume full power state when data is to be transmitted/received. However, in many cases, multiple ports may power up or power down simultaneously, also leading to calibration of multiple ports at the same time which can lead to network instability. This instability may result in link establishment failures due to excessive noise and interference, as well as abrupt power surges or drops. Further, traditional calibration methods often rely on extended training sequences that further lead to wastage of energy. Moreover, transitions between calibration sequences and payload data may lead to service disruptions. If calibration ends and data transmission resumes without a proper signaling mechanism or delay, a port may fail to recognize the shift, interpreting calibration sequences as valid data or missing the start of actual payload. This can result in incorrect decoding of errors, dropped packets, and unstable receiving network device behavior due to mismatches in internal state machines or timing recovery circuits leading to power surges or drops.

To overcome the aforementioned issues, in the present disclosure, a Green Mode (GM) power saving technique may be applied to the network device 102 to facilitate power control management at Ethernet Interface. The GM power saving technique may be an advanced power-saving technique configured to reclaim SerDes and Ethernet port power consumption during idle periods. According to the GM power saving technique, analog circuitry and some of the digital circuitry may be powered down to save power when a network link is idle. The GM power saving technique may be implemented to enable Ethernet devices, for example, the network device 102, to enter a low-power idle state when a network link, that connects the network device 102 to another network device, is idle. Further, the GM capability of a link partner associated with each port of the network device 102 and a link quality of a link between a port and the associated link partner may be utilized to implement a power control management feature on each port operating in a power-up state (active state) or a power-down state (idle state) of the network device 102. For example, each of the ports 104-108 has a feature enabled for the GM. When the link partner, for example, the link partner 110, is not detected, the port 104 may perform a power-down sequence that may configure the port 104 to transition from the power-up state to the power-down state. The power-up state may refer to an active power state of the network device 102 (more particularly, a port) during which the network device 102 may continue executing its operations. The power-down state may refer to a low-power mode of the network device 102 (more particularly, a port) in an idle condition that may include shutting down unused circuits while maintaining enough functionality for a quick wake-up. Further, clock signals to circuits such as an encoder, an error correction unit, and SerDes circuits of the network device 102 may be reduced or halted to minimize power usage. When the link partner 110 is detected, the port 104 may perform a power-up sequence that may configure the port 104 to transition from the power-down state to the power-up state.

The GM power saving technique may further implement mechanisms that may enable periodic calibration of a plurality of receiving circuitries of the link partners 110 114 irrespective of whether the respective ports 104-108 are in a power-down or a power-up state. The GM power saving technique may further implement mechanisms to manage simultaneous power state transitions in multiple ports 104-108.

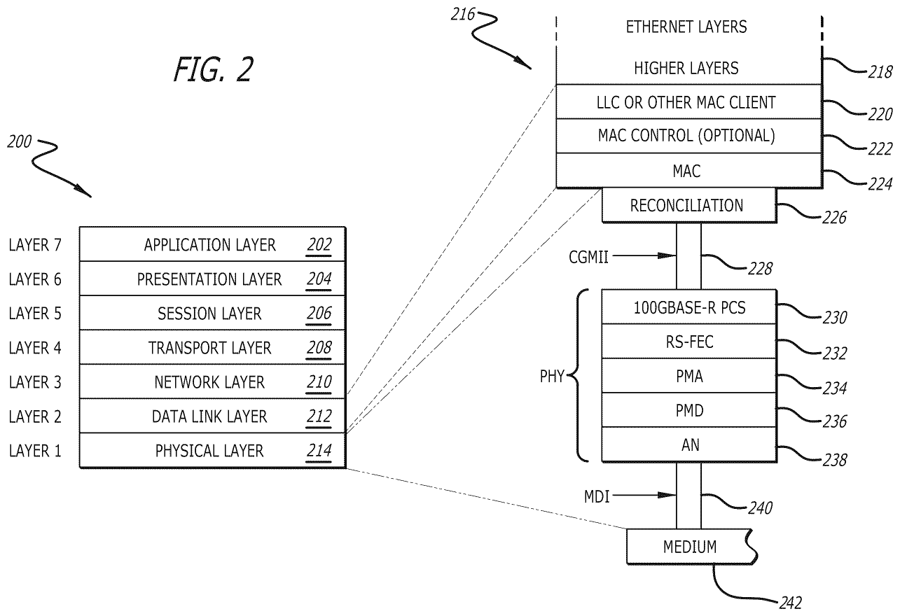

Although a specific embodiment for the networking environment 100 is described above with respect to FIG. 1, any of a variety of systems and/or processes may be utilized in accordance with embodiments of the disclosure. For example, the networking environment 100 may include a different number of link partners coupled to an equivalent number of ports of the network device 102 by way of an equivalent number of links. The elements depicted in FIG. 1 may also be interchangeable with other elements of FIG. 2-13 as required to realize a particularly desired embodiment.

Referring to FIG. 2, a schematic diagram of a communication layer architecture 200 in accordance with various embodiments of the disclosure is shown. In many embodiments, the communication layer architecture 200 can be utilized to carry out various communications described or required herein. In a number of embodiments, the communication layer architecture 200 may be configured as an Open Systems Interconnection (OSI) model. In a variety of embodiments, the communication layer architecture 200 may include seven layers which may be implemented in accordance with the OSI model. The seven layers include, for example, a physical layer 214, a data link layer 212, a network layer 210, a transport layer 208, a session layer 206, a presentation layer 204, and an application layer 202.

In various embodiments, the physical layer 214 may serve as a foundational layer among the seven layers. The physical layer 214 may represent the first layer of the OSI model and may be referred to as “layer 1”. The physical layer 214 may be responsible for an actual physical connection between devices and transmission and reception of raw, unstructured data over a physical medium (denoted as “medium 242”) including, for example, cables such as twisted pair cables, fiber optic cables, backplane traces, or the like, or wireless connections. The physical layer 214 may include physical equipment involved in a data transfer and electrical/optical, mechanical, and functional interfaces to the physical medium. The physical layer 214 may carry signals for the higher layers of the OSI model. The physical layer 214 may provide synchronization of bits through a clock, define a transmission rate, that is, the number of bits transmitted per second, define an arrangement of different devices in a network, and define how the data flows between the two connected devices. The devices operating at the physical layer 214 may include network cables such as Ethernet cables, fiber optic cables, or the like, connectors, repeaters, hubs, or the like.

In more embodiments, the data link layer 212 may provide an error-free transfer of data frames from one device to another over the physical layer 214, allowing the layers 202-210 above the data link layer 212 to assume a substantially error-free transmission over a link. The data link layer 212 may represent the second layer of the OSI model and may be referred to as “layer 2”. The data link layer 212 may be configured to perform framing, error detection and correction, flow control, access control, and addressing. An example of a protocol utilized in the data link layer 212 may be Ethernet. Ethernet may operate in the physical layer 214 and the data link layer 212 of the OSI model. The data link layer 212 may be divided into two sublayers: a Logical Link Control (LLC) sublayer 220 and a Media Access Control (MAC) sublayer 224. The LLC sublayer 220 may manage communication between devices on the network and handle error correction, flow control, and data link management. The LLC sublayer 220 may be responsible for identifying and encapsulating higher-layer protocols such as an Internet Protocol (IP). The MAC sublayer 224 may control how the devices access the physical medium and transmit data. The MAC sublayer 224 may handle the addressing of the devices using MAC addresses, access control methods, and how to handle the data frames when they are ready for transmission. The devices that operate at the data link layer may include, for example, Network Interface Cards (NICs), switches, bridges, or the like. The data link layer may facilitate creation of a reliable point-to-point or point-to-multipoint link for data transmission between neighboring devices.

In additional embodiments, the network layer 210 may control the operation of a subnet, determining which physical path the data should take based on network conditions, priority of service, and other factors. The network layer 210 may represent the third layer of the OSI model and may be referred to as “layer 3”. The network layer 210 may perform logical addressing, routing, and the fragmentation and reassembly of data packets. In further embodiments, the network layer 210 may ensure that the data is directed from a source to a destination, even when the devices are not directly connected. An example of a protocol utilized in the network layer 210 may be IP. The devices that operate at the network layer 210 may include, for example, routers, for routing data between different networks or subnets. The network layer 210 may determine an optimal path for data to traverse through a network based on logical addressing. The network layer 210 may abstract the underlying physical layer 214 and the data link layer 212, allowing for a more scalable and flexible communication infrastructure.

In still more embodiments, the transport layer 208 may facilitate delivery of error-free messages, in sequence, and with no losses or duplications. The transport layer 208 may represent the fourth layer of the OSI model and may be referred to as “layer 4”. The transport layer 208 may be responsible for end-to-end communication between two devices. The transport layer 208 may also provide an acknowledgment of a successful data transmission and re-transmit data if an error is found. The transport layer 208 may segment and reassemble the data for transmission between the devices, perform error detection and correction, ensure flow control, and manage data transmission rates. Examples of protocols utilized in the transport layer 208 may include a Transmission Control Protocol (TCP), User Datagram Protocol (UDP), Point-to-Point Tunneling Protocol (PPTP), or the like.

In still further embodiments, the session layer 206 may be responsible for the establishment of connections, management of connections, and terminations of sessions between two devices. The session layer 206 may facilitate session establishment between processes running on different devices. The session layer 206 may represent the fifth layer of the OSI model and may be referred to as “layer 5”. The session layer 206 may synchronize data exchange, allowing for full-duplex, half-duplex, or simplex communication. The session layer 206 may allow a process to add checkpoints that are considered synchronization points in the data. These synchronization points may assist in identifying an error to allow a proper resynchronization of the data, to preclude ends of messages from being cut prematurely, and to avoid data loss. The session layer 206 may manage the sessions between two communicating devices, ensuring that data flows in the correct order.

In still additional embodiments, the presentation layer 204 may format the data for presentation to the application layer 202. The presentation layer 204 may represent the sixth layer of the OSI model and may be referred to as “layer 6”. The presentation layer 204 may be responsible for translation, encryption, and compression of data between the application layer 202 and the transport layer 208. The presentation layer 204 may be viewed as a translator for the network. The presentation layer 204 may translate data from a format utilized by the application layer 202 into a common format at a transmitting device and then translate the common format to a format known by the application layer 202 at a receiving device.

In some more embodiments, the application layer 202 may serve as a window for users and application processes to access network services and for displaying received information to the users. The application layer 202 may represent the seventh layer of the OSI model and may be referred to as “layer 7”. The application layer 202 may be implemented by network applications that generate the data to be transmitted over the network. Examples of protocols utilized in the application layer 202 may include a HyperText Transfer Protocol (HTTP), Simple Mail Transfer Protocol (SMTP), File Transfer Protocol (FTP), Domain Name System (DNS), or the like. The application layer 202 may directly interact with end-user applications. The application layer 202 may provide network services to the applications and facilitate user interaction with the network. In yet various embodiments, the application layer 202 may operate as a mediator, allowing different software applications to communicate seamlessly across the network.

Further, the Ethernet interface may be defined by the Institute of Electrical and Electronics Engineers (IEEE) as layers of functions as illustrated in FIG. 2, as captured from the IEEE802.3cx standard. The embodiments illustrated in FIG. 2 are described in the context of Ethernet layers 216 including, for example, a reconciliation layer 226, a MAC sublayer 224, an optional MAC control layer 222, an LLC sublayer 220, and higher layers 218. The optional MAC control layer 222, the LLC sublayer 220, and the higher layers 218 may be referred to as “upper layers 218-222.” The reconciliation layer 226, the MAC sublayer 224, and the upper layers 218-222 may process incoming and outgoing packets and may not operate when the link is idle, and no packets are transmitted or received. In lower layers that are below the reconciliation layer 226, the MAC sublayer 224, and the upper layers 218-222, the packets may be converted into a continuous stream of bits. These bits may be scrambled to guarantee frequent bit transitions from zero to one and vice versa. The continuous scrambled bits may imply that the lower layers are never idle. The lower layers may process the stream of bits even when they do not carry real data traffic. In yet more embodiments, the reconciliation layer 226 may communicate with the Ethernet PHY layer via a Common Gigabit Media Independent Interface (CGMII) 228. The Ethernet PHY layer may represent a physical layer device. In further embodiments, the reconciliation layer 226 may provide a mapping between signals available at the CGMII 228 and the MAC sublayer 224. In still further embodiments, the reconciliation layer 226 may adapt bit serial protocols of the MAC sublayer 224 to parallel encodings of a 100GBASE-R Physical Coding Sublayer (PCS) 230. The reconciliation layer 226 may convert parallel data from the MAC sublayer 224 into a serial data stream and convert serial data received from the Ethernet PHY layer into parallel data for the MAC sublayer 224. In an example, in a 100 Gbps Ethernet PHY layer, the reconciliation layer 226 may handle the process of converting parallel 25 Gbps data streams into a single serial data stream for transmission.

In still yet more embodiments, the CGMII 228 may operate at speeds, for example, up to 1000 Mbps, implemented using a data interface clocked at 125 megahertz (MHz) with separate eight-bit data paths for receive and transmit. In many further embodiments, the CGMII 228 may support a 100 Gbps operation through its 64-bit-wide transmit and receive data paths. In further additional embodiments, the CGMII 228 may support the 100 Gbps operation through its 256-bit wide transmit and receive data paths. The CGMII 228 may be an extension of a 10 Gigabit Media Independent Interface (XGMII) and a Gigabit Media Independent Interface (GMII), configured for 100GBASE-R Ethernet. The Ethernet PHY layer may include 100GBASE-R PCS 230, Reed Solomon-Forward Error Correction (RS-FEC) 232, a Physical Medium Attachment (PMA) 234, and a Physical Medium Dependent (PMD) sublayer 236. 100GBASE-R may represent a group or family of physical layer devices, for example, 100 Gbps transceivers, where “BASE” may refer to a baseband transmission method in which the entire bandwidth of the medium 242 may be utilized to transmit a single data stream without any frequency multiplexing, and “R” may indicate a use of serial transmission over high-speed links in the 100 Gigabit Ethernet (100GbE) standard. In still more embodiments, the 100GbE may follow a 64b/66b encoding scheme, instead of an older 8b/10b encoding, and may utilize the RS-FEC to enhance data integrity.

The 100GBASE-R PCS 230 may support, for example, a transmission of data at a rate of 100 Gbps. The 100GBASE-R PCS 230 may be responsible for encoding and decoding data to be transmitted over the medium 242. The 100GBASE-R PCS 230 may further perform block synchronization, lane distribution, and error detection to ensure reliable high-speed transmission. For 100GbE, the 100GBASE-R PCS 230 may perform 64b/66b encoding, which may improve efficiency compared to the older 8b/10b encoding by reducing overhead while maintaining synchronization. The 100GBASE-R PCS 230 may also implement RS-FEC for data integrity, for example, in high-speed, long-distance links. The 100GBASE-R PCS 230 may distribute data across multiple lanes, for example, 4 or 10 lanes in 100GBASE standards, and ensure proper lane alignment at a receiving network device.

The RS-FEC 232 may refer to a RS-FEC codeword-interleaved sublayer that may be utilized for error correction during the transmission of the data. In many additional embodiments, the Ethernet PHY layer may include the RS-FEC 232 based on the type of physical layer device. The PMA 234 may refer to a sublayer of the Ethernet PHY layer responsible for providing an interface between the Ethernet PHY layer and the medium 242. The PMA 234 may refer to a sublayer of the Ethernet PHY layer responsible for ensuring that the data is properly encoded or decoded for transmission over the medium 242. In many further embodiments, the PMA 234 may perform serialization, deserialization, clock recovery, and signal conditioning in Ethernet communication. The PMA 234 may receive parallel data from the 100GBASE-R PCS 230, converts the parallel data into a serial data stream, and transmit the serial data stream to the PMD for transmission over the medium 242. On the receiving end, the PMA 234 may perform Clock and Data Recovery (CDR) to extract an embedded clock signal and reassemble the serial data into a parallel format for the 100GBASE-R PCS 230. The PMA 234 may also support multi-lane architectures, such as 100GBASE-R, where the PMA 234 may distribute or multiplex data across multiple lanes before transmission. The PMA 234 may operate directly with the PMD sublayer 236 to transmit and receive the data, for example, across cables or optical fibers.

The PMD sublayer 236 may define the electrical, optical, or radio signals utilize for transmission, and specifications for physical connectors. The PMD sublayer 236 may define characteristics and properties, for example, signal levels, encoding schemes, or the like, of the medium 242, and how the transmission and reception of the data interact with this medium 242. In many additional embodiments, the PMD sublayer 236 may directly interface with the MDI 240 and convert digital signals from the PMA 234 into a format suitable for transmission, for example, over copper cables, fiber optics, or wireless channels. The PMD sublayer 236 may include, for example, laser drivers and photodetectors for optical links such as the 100GBASE-Short Range 4 (SR4)/Long Range 4 (LR4), or transmitters and receiver for electrical signals in copper-based Ethernet such as 100GBASE-Copper Ribbon 4 (CR4). The PMD sublayer 236 may also define key parameters such as signal levels, modulation schemes, and transmission distances, ensuring reliable communication over different media types.

In still yet further embodiments, the Ethernet PHY layer may implement an Auto-Negotiation (AN) protocol 238 based on the type of physical layer device. The AN protocol 238 may allow the devices on the network to automatically detect and agree on the best possible communication parameters such as speed and duplex mode based on the capabilities of both the devices. The AN protocol 238 may operate at the physical layer 214 to ensure that both the devices on the link can automatically agree on an optimal configuration for communication. The Ethernet PHY layer may communicate with the medium 242 via a Medium Dependent Interface (MDI) 240. The MDI 240 may be a physical connection point between the Ethernet PHY layer and the medium 242. The MDI 240 may define how a device physically connects to the medium 242 via the Ethernet interface and how signals are transmitted over that medium 242. The MDI 240 may specify whether the device is connected, for example, to an MDI-X (crossed wiring for a direct connection) or MDI (non-crossed, direct-to-device) interface. In various embodiments, the MDI 240 may include, for example, connectors, transceivers, and physical ports that are utilized for data transmission. For example, in a fiber-optic Ethernet, the MDI 240 may include optical connectors and transceiver modules that interface with the PMD sublayer 236. In a copper-based Ethernet, the MDI 240 may include Registered Jack-45 (RJ-45) connectors, for example, for twisted-pair cables or Direct-Attach Copper (DAC) cables for high-speed links. The MDI 240 may ensure proper signal integrity and mechanical compatibility between network devices, allowing seamless connectivity across different Ethernet implementations through the medium 242.

The medium 242 may refer to a physical channel that transports Ethernet signals, and that can vary based on a specific Ethernet standard. The medium 242 may transport modulated signals, for example, electrical signals, optical signals, or wireless signals, between network devices, ensuring data integrity and minimal signal loss. The choice of the medium 242 may depend on speed, distance, interference resistance, and application requirements. The different types of the medium 242 may include, for example, an electrical copper medium utilized in twisted-pair cables such as Cat5e, Cat6, or Cat8 Ethernet cables, DAC cables, or the like, a light-based, optical fiber medium utilized in a Single-Mode Fiber (SMF) and Multi-Mode Fiber (MMF) for long-distance high-speed communication, a wireless medium such as radio waves utilized in the IEEE 802.11 standard, millimeter Wave (mmWave), free-space optical communication, or the like.

In still yet additional embodiments, the systems, devices, and methods discussed herein perform power control management at the Ethernet interface described in the context of Ethernet layers 216 illustrated in FIG. 2. In several embodiments, while the upper layers 218-222 may utilize clock gating techniques for reducing power consumption whenever there is no data traffic, the lower layers may continue to process incoming idle data patterns and consume power. The systems, devices, and methods discussed herein may provide a power management logic configured to power down the PMD sublayer 236 and the upper layers including, for example, the PMA 234, the RS-FEC 232, the 100GBASE-R PCS 230, the reconciliation layer 226, the MAC sublayer 224, and the upper layers 218-222. For example, the power management logic may be configured to execute a hop-by-hop protocol to power down a transmitter which in turn signals the associated receiver at a far end of a link to also power down. While powered down, the power management logic may perform a calibration to maintain the receiver clock synchronized to the remote transmitter clock. When new transmit data is present, the transmitter may power up and signal the receiver to power up as well. The systems, devices, and methods discussed herein may maintain a phase-locked loop in the receiver close to being locked for quick power-up time.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIG. 3-13 as required to realize a particularly desired embodiment.

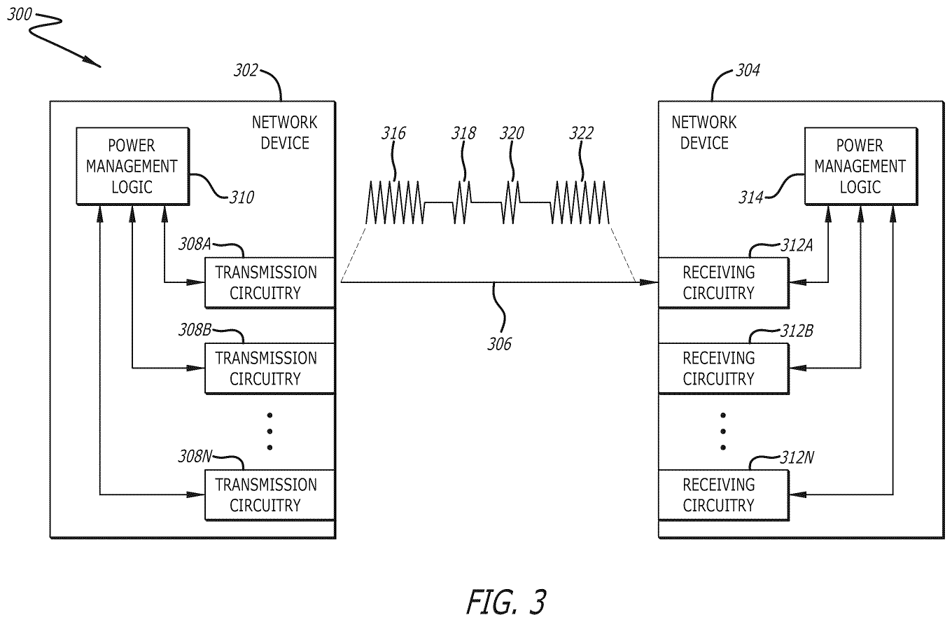

Referring to FIG. 3, a conceptual block diagram 300 of a connection between two network devices in accordance with various embodiments of the disclosure is shown. In an example embodiment shown in FIG. 3, the connection can be an Ethernet connection between two network devices 302 and 304. Examples of the network devices 302 and 304 may include switches, routers, servers, computing devices, network interface cards (NICs), or the like. The network devices 302 and 304 may support data transmission, data reception, and link management via a communication link 306, using physical and data link layer protocols. In a non-limiting example, the network device 302 is assumed to be a transmitting network device and the network device 304 is assumed to be a receiving network device. However, the scope of the disclosure is not limited to a network device functioning solely as a transmitting network device or as a receiving network device, as a network device may perform both transmitting and receiving functions. To distinguish between the network devices 302 and 304 while describing one or more corresponding transmitting or receiving functionalities, the network device 302 is referred to as a “transmitting network device 302” and the network device 304 is referred to as a “receiving network device 304”. However, depending on the direction of communication, the network device 304 can also function as a transmitting network device and the network device 302 may function as a receiving network device, without deviating from the scope of the disclosure.

In many embodiments, the transmitting network device 302 (e.g., a transmitter) may be configured to convert data into electrical signals to transmit over the communication link 306 to the receiving network device 304. The receiving network device 304 (e.g., a receiver) may be configured to receive the electrical signals from the transmitting network device 302 via the communication link 306. The communication link 306 may include, for example, twisted-pair cables, fiber-optic cables, wireless connections in Wi-Fi networks, or the like.

In various embodiments, the transmitting network device 302 may include a plurality of transmission circuitries 308A-308N, each configured to convert data into electrical signals for transmission over a corresponding communication link (e.g., the communication link 306). In an example, the plurality of transmission circuitries 308A 308N may support different Ethernet standards (e.g., 1G, 10G, 25G, or higher speeds) and may be configured to operate independently or in parallel. Each transmission circuitry 308A-308N may include its own PHY layer transceiver, PCS layer, MAC layer, and associated circuitry to manage transmission independently, for example, as described in the foregoing description of FIG. 2. For illustrative purposes and to avoid redundancy, the plurality of transmission circuitries 308A-308N is explained with reference to transmission circuitry 308A.

In the embodiment depicted in FIG. 3, the transmitting network device 302 may include a power management logic 310 configured to implement power control management for the transmitting network device 302. The power management logic 310 can include various hardware and/or software deployments and can be configured in a variety of ways. For example, the power management logic 310 can be a set of instructions stored within a non-volatile memory that, when executed by a processor(s) can carry out the steps for power control management of the plurality of transmission circuitries 308A 308N (e.g., Ethernet interfaces). Operations performed by the power management logic 310 may be considered as performed by the transmitting network device 302 as the power management logic 310 is included in or integrated with the transmitting network device 302.

The receiving network device 304 may further include a plurality of receiving circuitries 312A-312N configured to receive one or more signals transmitted over corresponding communication links from corresponding transmission circuitries. For example, a receiving circuitry 312A may receive one or more signals transmitted over the communication link 306 from the transmission circuitry 308A. For the sake of illustration, in FIG. 3 a connection between the transmission circuitry 308A and the receiving circuitry 312A over the communication link 306 is shown. However, it will be understood that the remaining receiving circuitries 312B-312N may also be coupled to corresponding transmission circuitries, which may or may not be part of the transmitting network device 302. These additional connections are omitted from FIG. 3 for simplicity. For the sake of brevity, the plurality of receiving circuitries 312A-312N is described in detail by way of example, with reference to receiving circuitry 312A. But the description may equally apply to the remaining receiving circuitries 312B-312N, which may include similar or equivalent components and functionality.

The receiving network device 304 may also include a power management logic 314 configured to enable periodic link calibration of the receiving network device 304. The power management logic 314 can include various hardware and/or software deployments and can be configured in a variety of ways. For example, the power management logic 314 can be a set of instructions stored within a non-volatile memory that, when executed by one or more processors can carry out the steps for power control management in the receiving network device 304. Operations performed by the power management logic 314 may be considered as performed by the receiving network device 304 as the power management logic 314 is included in or integrated with the receiving network device 304.

The receiving circuitry 312A may include a Serial/Deserializer (SerDes or SD) circuit, which in turn may include an analog section and a digital section. The analog section may be configured to convert an analog signal received from the transmitting network device 302 into a high-speed serial digital bit stream, resolving voltage swings into digital bits and performing clock recovery to synchronize the data. The digital section may be configured to convert the high-speed serial digital bit stream and de-serialize it back into parallel data. Both the analog section and the digital section may need calibration from time to time. Calibration may be required for reliable data transmission by compensating for variations in signal strength, timing, channel impairments, or device mismatches. Calibration may adjust parameters, for example gain, equalization, or clock alignment to optimize performance of the digital section and the analog section of the receiving circuitry 312A. Without calibration, high-speed or burst mode links may suffer from increased errors, reduced throughput, or unstable connections.

In a variety of embodiments, in order to calibrate the receiving network device 304 (in particular the receiving circuitry 312A), the power management logic 310 may be configured to generate a calibration sequence. The calibration sequence may refer to a signal pattern transmitted to adjust and optimize the receiving network device 304 or one or more link parameters of the communication link 306. The calibration sequence may include a calibration identifier and calibration data. The calibration identifier may refer to a specific bit pattern or signal, which indicates a start, a presence, or a type of calibration sequence within a data stream, enabling the receiving circuitry 312A to distinguish calibration data from regular payload data. The calibration identifier may be configured to precede the calibration data in the calibration sequence. For example, the calibration identifier may include, but is not limited to, one or more bits B₁ B₀.

In a variety of embodiments, the power management logic 310 may be configured to transmit the calibration sequence via the transmission circuitry 308A to the receiving network device 304 (more particularly, the receiving circuitry 312A). The calibration of the receiving circuitry 312A may occur periodically. For example, calibration may be scheduled at a plurality of periodic time instances. In other words, the power management logic 310 may be configured to transmit the calibration sequence at a periodic time instance of the plurality of periodic time instances. In a non-limiting example, the periodic time instances may occur every 100 microseconds (μs), 1 millisecond (ms), 1 second, or the like. In a non-limiting example, the calibration sequence may have a duration of 100 nanoseconds (ns), 500ns, 10 μs, 20 ms, or the like. In a number of embodiments, the calibration sequence may be configured for digital calibration or analog calibration at the receiving circuitry 312A.

In a case where the calibration sequence is configured for digital calibration at the receiving circuitry 312A, the calibration identifier may include one or more first identifier bits. In an example, the one or more first identifier bits may correspond to B₁=1 and B₀=0 (collectively referred to as S₂). In other words, the calibration identifier including the one or more first identifier bits (S₂) may indicate that the calibration sequence is for calibrating the digital section of the receiving circuitry 312A. Calibrating the digital section of the receiving circuitry 312A may include, for example, adjusting CDR parameters of the receiving circuitry 312A to align with incoming signal timing, tuning digital equalizers (e.g., tuning feed-forward equalizers or decision feedback equalizers) to compensate for channel impairments, calibrating threshold levels for accurate bit decision in slicers or comparators, synchronizing de-serializers (e.g., aligning bit or data boundaries), setting digital gain control values to ensure signal levels are within optimal detection range, performing digital offset correction to remove common-mode errors, resetting or adapting finite impulse response (FIR) filter coefficients used in signal conditioning, or the like. In a non-limiting example, the calibration sequence may have a duration ranging from 100 ns to 500 ns for calibrating the digital section of the receiving circuitry 312A.

In yet various embodiments, the calibration sequence having the one or more first identifier bits (S₂) as the calibration identifier may be configured to act as a beacon to communicate to the receiving circuitry 312A that the communication link 306 is active and alive. A beacon may refer to a periodic signal transmitted by the transmitting network device 302 to inform the receiving network device 304 that the communication link 306 is active and functional, even when no payload data is being sent. In Ethernet interfaces, where payload data is transmitted intermittently, the absence of payload data may be misinterpreted as a link failure or disconnection. The beacon may act as a lightweight, recognizable pattern configured to maintain synchronization, prevent link timeout, or ensure that the receiving circuitry 312A stays in a ready state to quickly resume data reception. The beacon may also enable monitoring of link health and can support functions such as wake-up signaling, link fault detection, or triggering of periodic calibration events.

In a case where the calibration sequence is configured for analog calibration at the receiving circuitry 312A, the calibration identifier may include one or more second identifier bits, which are different from the one or more first identifier bits. For example, the one or more second identifier bits may correspond to B₁=1 and B₀=1 (e.g., collectively referred to as S₃) and S₃≠S₂. In other words, the calibration identifier including the one or more second identifier bits (S₃) may indicate that the calibration sequence is for the analog section of the receiving circuitry 312A. Calibrating the analog section of the receiving circuitry 312A may include adjusting one or more front-end components of the receiving circuitry 312A to optimize signal reception and integrity, tuning the low-noise amplifier (LNA) gain, phase of phase rotator, to adapt to varying signal strengths, aligning the analog-to-digital converter (ADC) input range for accurate digitization, and compensating for offset and common-mode noise in the input stages. Calibration may also involve optimizing filter bandwidths to match signal characteristics, adjusting phase-locked loop (PLL) parameters for stable clock recovery, and equalizing analog signal paths to counteract distortion or loss introduced by the communication link 306.

In numerous embodiments, calibration of the analog section may involve a longer time duration than the calibration of the digital section of the receiving circuitry 312A. For example, calibrating the analog section may take longer than calibrating the digital section of the receiving circuitry 312A due to the inherent nature of analog components, which require physical settling time to stabilize after adjustments. Operations such as tuning amplifiers, filters, and PLLs may involve gradual changes and often depend on environmental factors such as temperature or voltage variations, necessitating precise or sometimes iterative calibration steps. Additionally, calibration of the analog section may be sequential and may require feedback from live signal measurements, further slowing the calibration process. In contrast, calibration of the digital section may be faster, software-driven, and can be executed through rapid logic adjustments with minimal delay. As a result, in a non-limiting example, a duration of the calibration sequence for analog calibration may range from 10 μs to 20 ms, while a duration of the calibration sequence for digital calibration may range from 100 ns to 500 ns. In a non-limiting example, the duration of the calibration sequence for analog calibration may be up to 100,000 times or 10,000 times longer than the duration of the calibration sequence for digital calibration.

In the example embodiment shown in FIG. 3, the power management logic 310 may detect that one or more data buffers or one or more data queues associated with the transmission circuitry 308A have been empty for a predetermined period of time. In such an embodiment, the power management logic 310 may control the transmission circuitry 308A to transition to a power-down state from a power-up state. The transmission circuitry 308A may transmit remaining payload sequence 316 before transitioning to the power-down state. Once powered-down, the power management logic 310 may transmit a first calibration sequence 318 at a first periodic time instance and a second calibration sequence 320 at a second periodic time instance, via the transmission circuitry 308A. In an example, the first calibration sequence 318 may be for calibrating the analog section of the receiving circuitry 312A and the second calibration sequence 320 may be for calibrating the digital section of the receiving circuitry 312A, or vice versa. In further examples, the first calibration sequence 318 and the second calibration sequence 320 may be for calibrating the digital section of the receiving circuitry 312A. In more examples, the first calibration sequence 318 and the second calibration sequence 320 may be for calibrating the analog section of the receiving circuitry 312A.

While in the power-down state, if the power management logic 310 detects a presence payload data in the one or more data buffers or the one or more data queues associated with the transmission circuitry 308A, the power management logic 310 may control the transmission circuitry 308A to transition to the power-up state from the power-down state. After the transmission circuitry 308A has transitioned to the power-up state, the transmission circuitry 308A may transmit payload data present in the one or more data buffers or the one or more data queues as a payload sequence 322.

In more embodiments, in case a periodic time instance of the plurality of periodic time instances for calibration occurs amidst an ongoing data transmission by the transmission circuitry 308A, the power management logic 310 may be configured to delay the periodic time instance. In other words, the power management logic 310 may be configured to complete the ongoing data transmission before transmitting the calibration sequence. Thus, based on the delayed periodic time instance, the power management logic 310 may be configured to transmit the calibration sequence via the transmission circuitry 308A after the ongoing data transmission is complete.

In yet more embodiments, the power management logic 310 may detect incoming data from a PCS layer while calibration is still going on (for example, while the calibration sequence is still being transmitted by the transmission circuitry 308A). For example, the power management logic 310 may be configured to receive a data transmission request during the transmission of the calibration sequence. In such embodiments, the power management logic 310 may transmit, via the transmission circuitry 308A, an indication to specify an end of the calibration sequence in response to receiving the data transmission request amidst the transmission of the calibration sequence. The power management logic 310 may be further configured to transmit a payload sequence associated with the data transmission request after the indication. The payload sequence may refer to incoming data that may carry actual user or application data, excluding overhead, control, or calibration data. The payload sequence may further include a data identifier and payload data, and the data identifier may precede the payload data in the payload sequence. The data identifier may refer to specific bit pattern or marker used to indicate the start or presence of valid payload data within a transmitted payload sequence. The data identifier may be configured distinguish the following payload data from the calibration data. The data identifier may include one or more third identifier bits that may be different from the one or more first identifier bits or the one or more second identifier bits. For example, the one or more third identifier bits may correspond to B₁=0 and B₀=0 (e.g., collectively referred to as S₀) and S₀≠S₂≠S₃. In other words, the one or more third identifier bits (S₀) may indicate payload transmission activity to the receiving circuitry 312A. Thus, calibration may take place during a power-up state or a power-down state of the transmission circuitry 308A.

In yet more embodiments, if the transmission circuitry 308A is transitioning from the power-down state to the power-up state, the power management logic 310 may be configured to transmit a preamble sequence before transmitting the calibration sequence or the payload sequence. The preamble sequence may be configured to wake up the receiving circuitry 312A from the power-down state. The preamble sequence may refer to a preparatory segment transmitted ahead of the calibration sequence or the payload sequence to enable the receiving circuitry 312A to establish synchronization, perform clock and data recovery, and identify the start of valid data. Accordingly, the power management logic 310 may be configured to generate the preamble sequence and transmit the preamble sequence via the transmission circuitry 308A to the receiving circuitry 312A. The preamble sequence may be configured to wake the receiving circuitry 312A from the power-down state to the power-up state. The transmission of the preamble sequence may precede the transmission of the calibration sequence. In an example, the preamble sequence may include a Clock and Data Recovery (CDR) lock pattern and at least one start identifier bit. The CDR lock pattern may refer to a clock pattern configured to quickly synchronize an internal clock of the receiving network device 304 with incoming data for accurate sampling and decoding of subsequent bits. Meanwhile, the start identifier bit may refer to a reference bit, which may signal a boundary between the preamble sequence and the calibration sequence or the payload sequence, allowing the receiving circuitry 312A to reliably detect the beginning of the incoming data. The start identifier bit may be one or more zero-energy pulses transmitted at the end of the preamble sequence before the start of the calibration sequence or the payload sequence.

When the transmission circuitry 308A transmits an input sequence (e.g., a calibration sequence or a payload sequence), the receiving circuitry 312A may not be aware of the nature of the input sequence. In several embodiments, the power management logic 314 may be configured to receive the input sequence via the receiving circuitry 312A over the communication link 306. The input sequence may include a transmission identifier and data with the transmission identifier preceding the data. The power management logic 314 may be configured to identify the received input sequence as one of the calibration sequence or the payload sequence based on the transmission identifier. The transmission identifier may refer to a bit pattern used to indicate an initiation or type of data transmission, helping the power management logic 314 to recognize and interpret incoming data correctly. For example, the transmission identifier may include bits B₁ B₀, where B₁ B₀ can be any of “00”, “10”, or “11”.

In additional embodiments, the power management logic 314 may be further configured to identify the received input sequence as the calibration sequence based on the transmission identifier corresponding to one of the one or more first identifier bits or the one or more second identifier bits. For example, if the transmission identifier corresponds to either S₂ or S₃, the power management logic 314 may identify the received input sequence as the calibration sequence. Accordingly, the power management logic 314 may calibrate the receiving circuitry 312A based on the identification of the received input sequence as the calibration sequence. In various embodiments, the power management logic 314 may calibrate the digital section based on the identification of the received input sequence as the calibration sequence and the transmission identifier corresponding to the one or more first identifier bits (S₂). Further, the received input sequence having the one or more first identifier bits as the transmission identifier may act as a beacon to indicate to the receiving circuitry 312A that the communication link 306 is active. In more embodiments, the power management logic 314 may calibrate the analog section based on the identification of the received input sequence as the calibration sequence and the transmission identifier corresponding to the one or more second identifier bits (S₃). On the contrary, the power management logic 314 may identify the received input sequence as the payload sequence based on the transmission identifier corresponding to the one or more third identifier bits (S₀) and thus, process the payload sequence accordingly.

Although a specific embodiment for a connection between two network devices suitable for carrying out the various steps, processes, methods, and operations described herein is discussed with respect to FIG. 3, any of a variety of systems and/or processes may be utilized in accordance with embodiments of the disclosure. For example, if the power management logic 310 receives a power transition request for a first transmission circuitry of the plurality of transmission circuitries 308A-308N, while a second transmission circuitry of the plurality of transmission circuitries 308A-308N is undergoing power state transition, the transmitting network device 302 may be configured to delay the power state transition of the first transmission circuitry until the power state transition of the second transmission circuitry is complete. The elements depicted in FIG. 3 may also be interchangeable with other elements of FIG. 1-2 and FIG. 4-13 as required to realize a particularly desired embodiment.

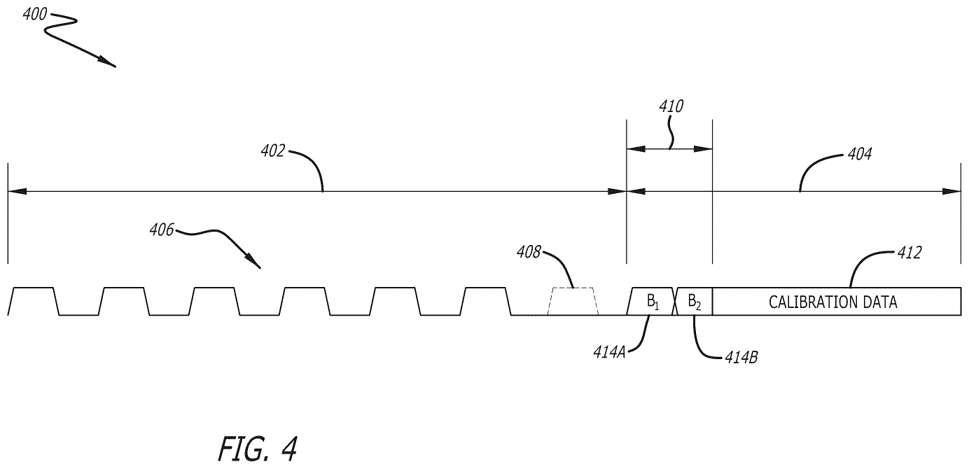

Referring to FIG. 4, a conceptual diagram that illustrates a data transmission sequence 400 in accordance with various embodiments of the disclosure is shown. The transmission sequence 400 may be generated by a transmitting network device while transitioning from a power-down state to a power-up state. In a non-limiting example, a transition of the transmitting network device from the power-down state to the power-up state (or vice versa), may correspond to a transition of a transmission circuitry (e.g., at least one of a plurality communication interfaces) of the transmitting network device from the power-down state to the power-up state (or vice versa). The transmitting network device may be communicatively coupled to a receiving network device over a communication link. The connection between the transmitting network device and the receiving network device may be an Ethernet connection. The receiving network device may also transition to the power-up state in coordination with the transmitting network device. In a non-limiting example, a transition of the receiving network device from the power-down state to the power-up state (or vice versa), may correspond to a transition of a receiving circuitry (e.g., at least one of a plurality communication interfaces) of the receiving network device from the power-down state to the power-up state (or vice versa).

In many embodiments, the transmitting network device may transmit the transmission sequence 400 to wake the receiving network device from the power-down state and initiate a power-up sequence. In FIG. 4, the transmission sequence 400 is shown to include a preamble sequence 402 and a calibration sequence 404. The preamble sequence 402 may refer to a signal pattern transmitted ahead of the calibration sequence 404 to enable the receiving network device to establish synchronization, perform clock and data recovery, and identify the start of valid data upon transitioning to the power-up state. The calibration sequence 404 may refer to a predefined signal pattern transmitted to adjust and optimize link parameters of the receiving network device and the communication link for accurate data recovery and reliable communication. Thus, the transmitting network device may transmit the preamble sequence 402 before transmitting the calibration sequence 404 to wake up the receiving network device.

In more embodiments, the preamble sequence 402 may include a CDR lock pattern 406 and at least one start identifier bit 408. The CDR lock pattern 406 may refer to a clock pattern configured to synchronize an internal clock of the receiving network device with incoming data for accurate sampling and decoding of subsequent bits. Examples of CDR lock pattern 406 may include bit sequences with frequent transitions to help the receiving network device to extract timing information effectively. For example, C8 (in hexadecimal) may represent a known repeating pattern such as 11001000 (in binary), which is used as part of a comma or training sequence to assist in CDR and byte alignment om high speed SerDes circuits. Meanwhile, the start identifier bit 408 may refer to a reference bit that may be configured to signal a boundary between the preamble sequence 402 and the calibration sequence 404, allowing the receiving network device to detect the beginning of valid data (e.g., the calibration sequence 404). In a non-limiting example, the start identifier bit 408 may be one or more zero-energy pulse transmitted at the end of the preamble sequence 402 and before the start of the calibration sequence 404. In more examples, the start identifier bit 408 may correspond to a missing pulse in the CDR lock pattern 406.

In yet more embodiments, the calibration sequence 404 may include a calibration identifier 410 followed by calibration data 412. The calibration identifier 410 may include one or more first identifier bits or one or more second identifier bits. For example, the calibration identifier 410 may include bits B₁ 414A and B₀ 414B, where B₁ B₀ can be “10” (the one or more first identifier bits “S₂”) or 11 (the one or more second identifier bits “S₃”). Various other sequences may be also utilized as the calibration identifier 410 and the above bit values do not limit the scope of the disclosure.

In still more embodiments, the calibration data 412 following the calibration identifier 410 may refer to a set of signals or patterns transmitted to adjust and optimize the receiving network device or link parameters for accurate and stable communication. For example, the calibration data may be a repetitive bit pattern like 10101010, used to adjust receiving gain, equalization, or clock recovery before normal data transmission begins.

In yet more embodiments, if the calibration sequence 404 includes the one or more first identifier bits (S₂), the calibration sequence 404 may be configured for calibrating a digital section of the receiving network device. However, if the calibration sequence 404 includes the one or more second identifier bits (S₃), the calibration sequence 404 may be configured for calibrating an analog section of the receiving network device.

Although a specific embodiment for a transmission sequence 400 suitable for carrying out the various steps, processes, methods, and operations described herein is discussed with respect to FIG. 4, any of a variety of systems and/or processes may be utilized in accordance with embodiments of the disclosure. For example, the transmission sequence 400 may include a preamble sequence followed by a payload sequence. The payload sequence may follow the preamble sequence if an immediate payload data transmission is required as soon as the receiving network device wakes up. Further, the payload sequence may follow the preamble sequence when the calibration of the receiving network device is already completed during an earlier periodic calibration time instance. The detailed explanation for the embodiment is provided in the section below. The elements depicted in FIG. 4 may also be interchangeable with other elements of FIG. 1-3 and FIG. 5-13 as required to realize a particularly desired embodiment.

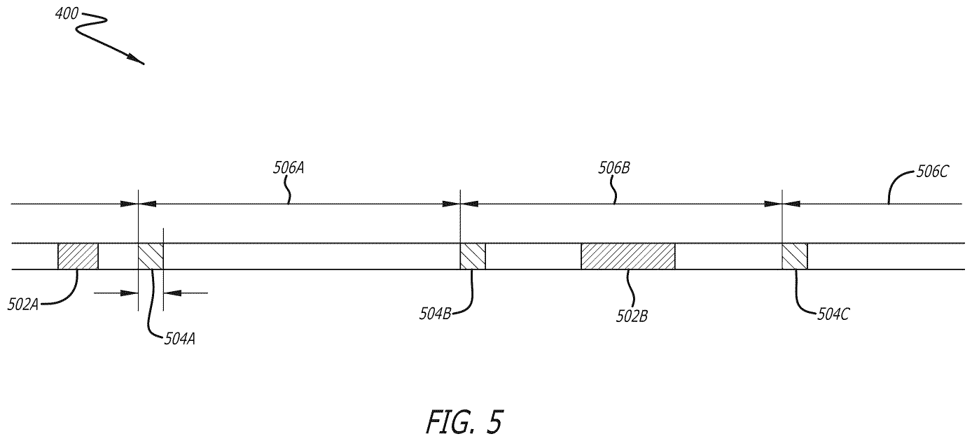

Referring to FIG. 5, a conceptual timing diagram 500 that illustrates flow of data via a communication link over a period of time in accordance with various embodiments of the disclosure is shown. In various embodiments, the communication link may be a medium for data transmission between a transmitting network device and a receiving network device. In the embodiment shown in FIG. 5, data transmission may occur in burst mode from time to time. In one or more embodiments, the transmitting network device may include a transmission circuitry that is in a power-up state to transmit payload sequences 502A and 502B to a receiving circuitry of the receiving network device.

In many embodiments, calibration of the receiving network device (for example, the receiving circuitry) may take place periodically irrespective of whether the transmitting network device is in a power-down or a power-up state. The transmitting network device may be equipped with a power management logic configured to generate calibration sequences 504A, 504B, 504C to calibrate the receiving circuitry. The power management logic may be configured to transmit the calibration sequences 504A-504C, via the transmission circuitry, at periodic time instances of a plurality of periodic time instances. For example, time intervals 506A, 506B, 506C correspond to periodic time intervals at start of which the respective calibration sequences 504A-504C are transmitted. As shown in FIG. 5, the calibration sequence 504A may be transmitted at a periodic time instance that is at the start of time interval 506A. Similarly, subsequent calibration sequences 504B and 504C are transmitted at the start of respective time intervals 506B and 506C. In several embodiments, the calibration sequences 504A-504C may be configured for digital calibration or analog calibration at the receiving network device.

Although a specific embodiment for flow of data via a communication link over a period of time suitable for carrying out the various steps, processes, methods, and operations described herein is discussed with respect to FIG. 5, any of a variety of systems and/or processes may be utilized in accordance with embodiments of the disclosure. For example, in case a periodic time instance of a plurality of periodic time instances for calibration occurs amidst an ongoing data transmission, the power management logic may delay the periodic time instance. Based on the delayed periodic time instance, the power management logic may transmit the calibration sequence, via the transmission circuitry, after the ongoing data transmission is complete. The elements depicted in FIG. 5 may also be interchangeable with other elements of FIG. 1-5 and FIGS. 6A, 6B, 6C, and 7-13 as required to realize a particularly desired embodiment.

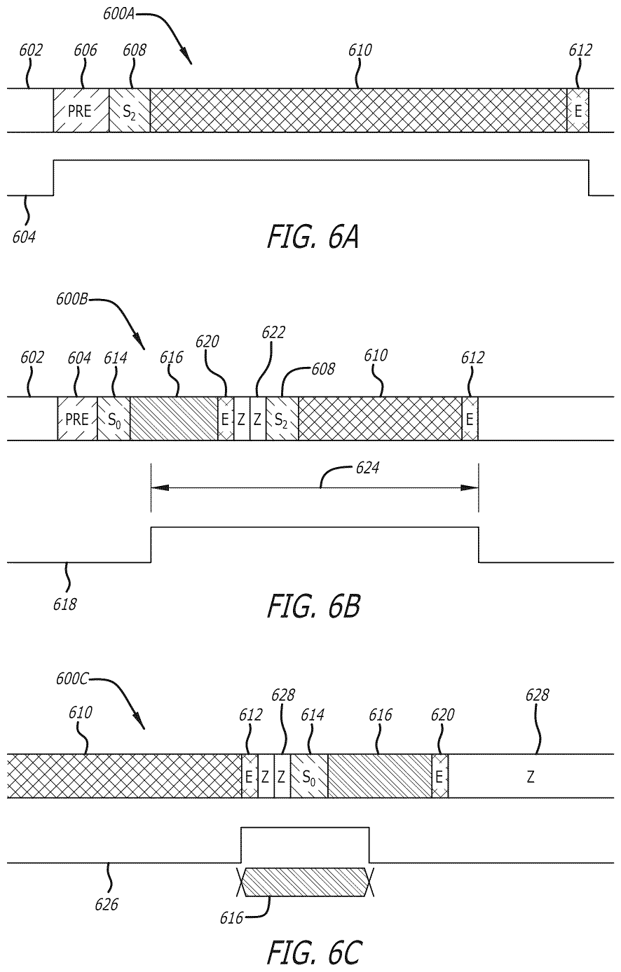

Referring to FIGS. 6A, 6B, and 6C, timing diagrams 600A, 600B, and 600C depicting switching scenarios between calibration sequences and payload sequences in accordance with various embodiments of the disclosure are shown. Data transmission may occur between a transmission circuitry of a transmitting network device and a receiving circuitry of a receiving network device over a communication link. The communication link may be a medium for data transmission between the transmission circuitry and the receiving circuitry. In an example, the communication link may be a link for an Ethernet connection. The transmitting network device may also include a power management logic configured to manage a periodic calibration of the receiving circuitry.

Referring to FIG. 6A, the timing diagram 600A for calibrating the receiving circuitry of the receiving network device in a power-down state is shown. In the example embodiment depicted by the timing diagram 600A, the transmission circuitry may also be in the power-down state, and no data transmission occurs initially. The absence of data transmission is represented by a zero-energy signal 602.

The power management logic may be configured to generate a calibration sequence to calibrate the receiving circuitry at a plurality of periodic time instances. Accordingly, at a scheduled periodic time instance from the plurality of periodic time instances, the power management logic may provide a calibration request 604 to the transmission circuitry. In an example, the calibration request 604 may include a preamble sequence 606 and a calibration sequence.

In many embodiments, the transmission circuitry, based on receiving the calibration request 604, may transmit the preamble sequence 606 to the receiving circuitry via the communication link. The preamble sequence 606 may be configured to wake up the receiving circuitry from the power-down state for periodic calibration. Further, the transmission circuitry may transmit the calibration sequence to calibrate the receiving circuitry. The calibration sequence may include a calibration identifier 608, followed by calibration data 610. In further embodiments, the calibration sequence may also include an endpoint identifier 612 (denoted as “E” in FIG. 6A) after the calibration data 610. The endpoint identifier 612 may correspond to an indication that specifies an end of the calibration sequence. In an example, the endpoint identifier 612 can be any pre-configured pattern that can indicate to the receiving circuitry that the calibration sequence has ended.

In more embodiments, the calibration identifier 608 may include one or more first identifier bits or one or more second identifier bits. The one or more first identifier bits (e.g., “10”, denoted as S₂) may correspond to calibration of a digital section of the receiving circuitry, while the one or more second identifier bits (e.g., “11”, denoted as S₃) may correspond to calibration of an analog section of the receiving circuitry. The calibration sequence with the one or more first identifier bits may further act as a beacon to wake up and synchronize the receiving circuitry. In a non-limiting example, the calibration identifier 608 is shown to include the one or more first identifier bits in FIG. 6A.

Referring to FIG. 6B, the timing diagram 600B depicting a handover from payload sequence transmission to calibration sequence transmission in accordance with various embodiments of the disclosure is shown. In the example embodiment depicted by the timing diagram 600B, the transmission circuitry may be in the power-down state, and no data transmission occurs initially. The absence of data transmission is represented by a zero-energy signal 602. When the power management logic detects presence of payload data 616 for transmission, the power management logic may signal the transmission circuitry to transition to a power-up state. The transmission circuitry may transition to the power-up state, and transmit a preamble sequence 606 (denoted as “PRE” in FIG. 6A) to the receiving circuitry. The preamble sequence 606, when received by the receiving circuitry, may wake up the receiving circuitry from the power-down state. Further, the transmission circuitry may transmit a payload sequence after the preamble sequence 606. The payload sequence may include a data identifier 614 followed by the payload data 616. The data identifier 614 (denoted as S₀) may include one or more third identifier bits (e.g., “00”).

After the preamble sequence 606, the receiving circuitry may receive the payload sequence from the transmission circuitry. The receiving circuitry may identify that the received sequence corresponds to the payload sequence because of the presence of the data identifier 614 which includes the one or more third identifier bits.

While the payload sequence is being transmitted by the transmission circuitry, the transmission circuitry may receive a calibration request 618 from the power management logic (for example, at the start of a scheduled periodic time interval 624) to calibrate the receiving circuitry. However, a priority of payload data transmission may be higher than a priority of calibration sequence transmission. In such a scenario, the transmission of the calibration sequence is delayed to a configured time period, such that payload sequence transmission gets completed before the configured time period. Payload sequence transmission completion is indicated by an endpoint identifier 620 (denoted as “E”), followed by at least two zero-energy pulses 622 (denoted as “Z”). Based on receiving the endpoint identifier 620 followed by the at least two zero-energy pulses 622, the receiving circuitry may detect the completion of the payload sequence transmission.

As the transmission of the payload sequence ends and the configured time period occurs, the transmission circuitry may transmit the calibration sequence. In the example embodiment shown in FIG. 6B, the calibration sequence includes a calibration identifier 608 (denoted by S₂) followed by calibration data 610. In further embodiments, the calibration sequence may also include an endpoint identifier 612 (denoted as “E”) after the calibration data 610. The endpoint identifier 612 may specify an end of the calibration sequence.

The receiving circuitry may receive the calibration sequence. Further, the receiving circuitry may identify that the received sequence corresponds to the calibration sequence because of the presence of the calibration identifier 608 that includes one or more second identifier bits (denoted by “S₂”). The received calibration sequence may be utilized by the receiving circuitry for calibration.

Referring to FIG. 6C, the timing diagram 600C depicting a handover from calibration sequence transmission to payload sequence transmission in accordance with various embodiments of the disclosure is shown. The transmission circuitry may be transmitting a calibration sequence (e.g., calibration data 610) to the receiving circuitry, when the power management logic detects the presence of payload data 616 for transmission. As a result, the power management logic may transmit a data valid signal 626 (e.g., a data transmission request) to the transmission circuitry. Based on the data valid signal 626, the transmission circuitry may end the transmission of the calibration sequence, and transmit an indication (e.g., an endpoint identifier 612, denoted as “E”) that specifies an end of the calibration sequence. The endpoint identifier 612 may be followed by at least two zero-energy pulses to end the transmission of the calibration sequence.

After indicating the end of the calibration sequence, the transmission circuitry may start the transmission of a payload sequence. The payload sequence may include a data identifier 614 (denoted as “S₀”) followed by the payload data 616 corresponding to the data valid signal 626. The receiving circuitry may identify the received payload sequence based on the presence of the data identifier 614 in the payload sequence. The payload sequence may end with an endpoint identifier 620 (denoted as “E”) followed by at least one zero-energy signal 628 (denoted as “Z”) to indicate an end of payload sequence transmission.

Although specific embodiments depicting switching scenarios between calibration sequences and payload sequences suitable for carrying out the various steps, processes, methods, and operations described herein is discussed with respect to FIGS. 6A, 6B, 6C, any of a variety of systems and/or processes may be utilized in accordance with embodiments of the disclosure. For example, the transmitting network device may include a plurality of transmission circuitries which may simultaneously attempt to transition from one power state to another power state. However, a timing controller may be configured in the transmitting network device which can stagger such simultaneous power state transitions over a period of time. The elements depicted in FIGS. 6A, 6B, and 6C may also be interchangeable with other elements of FIG. 1-5 and FIG. 7-13 as required to realize a particularly desired embodiment.

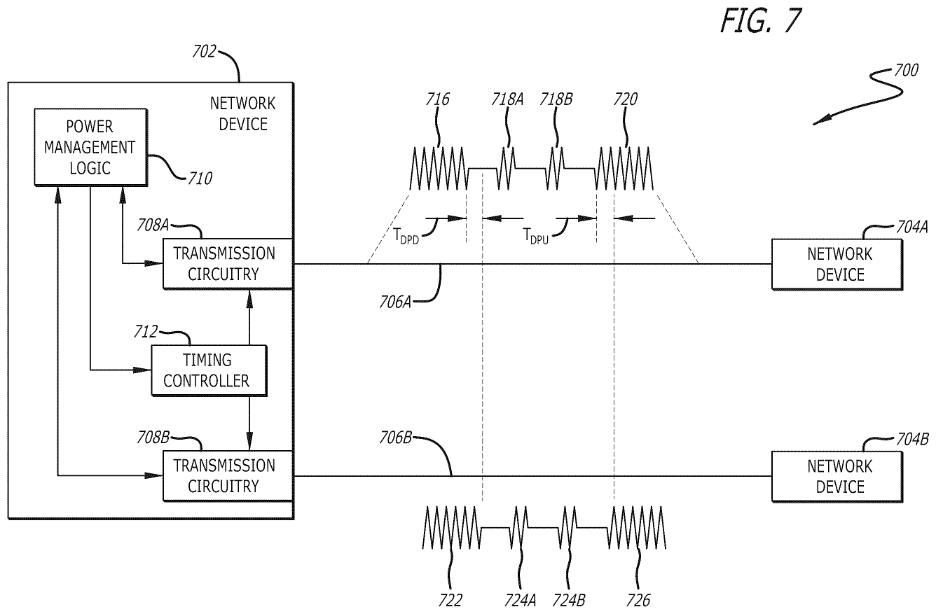

Referring to FIG. 7, a conceptual diagram 700 of timing control management in an Ethernet interface in accordance with various embodiments of the disclosure is shown. In the example embodiment shown in FIG. 7, a network device 702 may be coupled to at least two network devices 704A and 704B over communication links 706A and 706B, respectively. The at least two network devices 704A and 704B may be configured to receive data transmitted by the network device 702. To distinguish between the network device 702 and the at least two network devices 704A and 704B, the network device 702 may be referred to as “transmitting network device 702” and the at least two network devices 704A and 704B may be referred to as “receiving network devices 704A and 704B” hereinafter.

The transmitting network device 702 may include a plurality of transmission circuitries coupled to a plurality of receiving network devices via a plurality of communication links. For the sake of brevity, in the example embodiment shown in FIG. 7, only two transmission circuitries 708A and 708B coupled to two receiving network devices 704A and 704B via the communication links 706A and 706B, respectively, are depicted. The transmitting network device 702 may further include a power management logic 710 configured to manage power state transitions of the transmission circuitries 708A and 708B. Power state transition may include a transition from a power-down state to a power-up state or a transition from the power-up state to the power-down state.

In many embodiments, the power management logic 710 may be coupled to a timing controller 712. The timing controller 712 may include various hardware and/or software deployments and can be configured in a variety of ways. For example, the timing controller 712 can be a set of instructions stored within a non-volatile memory that, when executed by processor(s) can carry out the steps for managing simultaneous power state transitions of the transmission circuitries 708A and 708B.

In various embodiments, the transmission circuitry 708A may detect that there is no data to transmit based on an empty status of one or more data buffers or one or more data queues associated with the transmission circuitry 708A. Thus, the transmission circuitry 708A may transmit a power transition request to the power management logic 710 to transition from a power-up state to a power-down state. In more embodiments, the power transition request to transition the transmission circuitry 708A from the power-up state to the power-down state may be generated by the power management logic 710 based on monitoring of the one or more data buffers or one or more data queues associated with the transmission circuitry 708A.

In a variety of embodiments, the power management logic 710 may be configured to allow the transmission circuitry 708A to transition from the power-up state to the power-down state based on the power transition request. For example, the power management logic 710 may determine that no other transmission circuitry of the transmitting network device 702 is undergoing power state transition at a time requested by the transmission circuitry 708A. Consequently, the power management logic 710 may allow the transmission circuitry 708A to transition to the power-down state at the requested time.

As a result, the transmission circuitry 708A may initiate a power down sequence to transition to the power-down state. In other words, after transmitting last payload sequence 716, the transmission circuitry 708A may initiate the power down sequence. In an example, the power down sequence may involve halting of a PCS layer and a Forward Error Correction (FEC) encoder associated with the transmission circuitry 708A, and signaling the receiving network device 704A that the payload sequence 716 is the last data transmission from the transmission circuitry 708A. Consequently, the receiving network device 704A may begin its own power down sequence.

While the transmission circuitry 708A is executing the power down sequence, the power management logic 710 may receive a new power transition request from the transmission circuitry 708B. In an example, the power transition request from the transmission circuitry 708B can be for transitioning from the power-up state to the power-down state or for transitioning from the power-down state to the power-up state. In a non-limiting example, it is assumed that the power transition request from the transmission circuitry 708B is for transitioning from the power-up state to the power-down state. In such a scenario, the power management logic 710 may be configured to utilize the timing controller 712 to assign a time delay “T_{DPD}” 714A to the power transition request of the transmission circuitry 708B. Based on the assigned time delay “T_{DPD}” 714A, the transitioning of the transmission circuitry 708B from the power-up state to the power-down state may be staggered or delayed till the power state transition of the transmission circuitry 708A is complete.

In an example, the timing controller 712 may include a timer. The timing controller 712 may be configured to load the timer with the assigned time delay “T_{DPD}” 714A and start the timer based on an indication from the power management logic 710 to delay power state transition of the transmission circuitry 708B by a time duration “T_{DPD}”. Further, based on an expiration of the timer (e.g., after the time duration “T_{DPD}”), the timing controller 712 may trigger (e.g., a timeout signal) the transmission circuitry 708B to start the power-down sequence. Consequently, the transmission circuitry 708B may start the power down sequence, which may involve halting of a PCS layer and an FEC encoder associated with the transmission circuitry 708B, and signaling the receiving network device 704B that a payload sequence 722 is the last data transmission from the transmission circuitry 708B. As a result, the receiving network device 704B may also begin its own power down sequence based on the signaling from the transmission circuitry 708B.

In further embodiments, the transmission circuitry 708B may be configured to transmit a hydro list during the time duration T_{DPD}. Hydro list may refer to dummy data that may enable synchronization between the transmission circuitry 708B and the receiving network device 704B during the delay period.

In numerous embodiments, during the power-down state, the power management logic 710 may perform a periodic calibration of the receiving network devices 704A and 704B. For example, the power management logic 710 may control the transmission circuitry 708A to transmit a calibration sequence 718A at a first periodic time instance and another calibration sequence 718B at a second periodic time instance to calibrate the receiving network device 704A. Likewise, the power management logic 710 may control the transmission circuitry 708B to transmit a calibration sequence 724A at a third periodic time instance and another calibration sequence 724B at a fourth periodic time instance to calibrate the receiving network device 704B.

While being in the power-down state, the transmission circuitry 708A may detect incoming data from the PCS layer and may request the power management logic 710 to transition to the power-up state from the power-down state. Based on the request, the power management logic 710 may allow the transmission circuitry 708A to transition to the power-up state from the power-down state. For example, the power management logic 710 may determine that no other transmission circuitry of the transmitting network device 702 is undergoing power state transition at a time requested by the transmission circuitry 708A. Consequently, the power management logic 710 may allow the transmission circuitry 708A to transition to the power-up state at the requested time. As a result, the transmission circuitry 708A may initiate a power-up sequence to transition to the power-up state.

While the transmission circuitry 708A is executing the power-up sequence, the power management logic 710 may receive a new power transition request from the transmission circuitry 708B. In an example, the power transition request from the transmission circuitry 708B may be for transitioning from the power-down state to the power-up state. In such a scenario, the power management logic 710 may be configured to utilize the timing controller 712 to assign a time delay “T_{DPU}” 714B to the power transition request of the transmission circuitry 708B. Based on the assigned time delay “T_{DPU}” 714B, the transitioning of the transmission circuitry 708B from the power-down state to the power-up state may be staggered or delayed till the power state transition of the transmission circuitry 708A is complete.

In an example, the timing controller 712 may load the timer with the assigned time delay “T_{DPU}” 714B and start the timer based on an indication from the power management logic 710 to delay power state transition of the transmission circuitry 708B by a time duration “T_{DPU}”. Further, based on an expiration of the timer (e.g., after the time duration “T_{DPU}”), the timing controller 712 may trigger (e.g., a timeout signal) the transmission circuitry 708B to start the power-up sequence. Consequently, the transmission circuitry 708B may start the power-up sequence, which may involve resuming the PCS layer and the FEC encoder associated with the transmission circuitry 708B.

In additional embodiments, after transitioning to the power-up state, the transmission circuitry 708A may transmit a preamble sequence to wake up the receiving network device 704A. After the preamble sequence, the transmission circuitry 708A may start a transmission of a payload sequence 720 to the receiving network device 704A which has already been calibrated and synchronized during the power-down state. Likewise, after transitioning to the power-up state after the assigned time delay of T_{DPU}, the transmission circuitry 708B may also transmit a preamble sequence to wake up the receiving network device 704B. After the preamble sequence, the transmission circuitry 708B may start a transmission of a payload sequence 726 to the receiving network device 704B which is already calibrated and synchronized.

Although a specific embodiment for timing control management in an Ethernet interface suitable for carrying out the various steps, processes, methods, and operations described herein is discussed with respect to FIG. 7, any of a variety of systems and/or processes may be utilized in accordance with embodiments of the disclosure. For example, the staggered power management and periodic calibration performed by the transmitting network device 702 may similarly be performed by the receiving network devices 704A and 704B, and vice versa. For example, the transmitting network device 702 may include receiving capabilities, and the receiving network devices 704A and 704B may include transmitting capabilities. Accordingly, their roles may be dynamically reversed during data transmission, depending on the direction of communication. The elements depicted in FIG. 7 may also be interchangeable with other elements of FIG. 1-5 and FIG. 7-13 as required to realize a particularly desired embodiment.

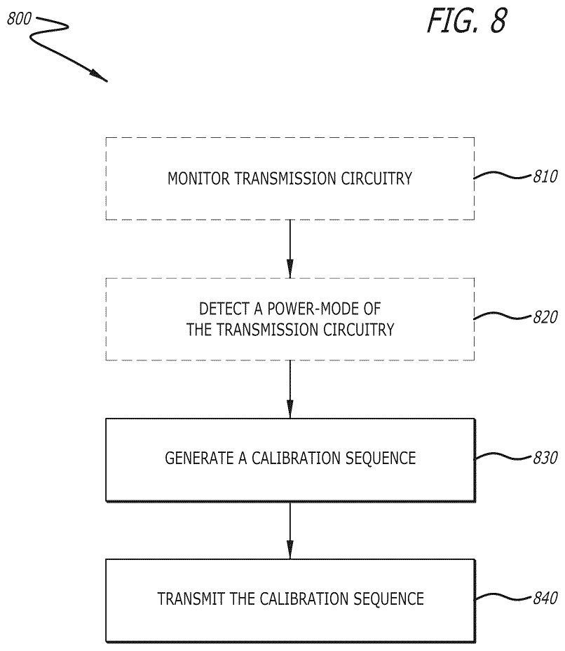

Referring to FIG. 8, a flowchart depicting a process 800 for calibrating a receiving network device in accordance with various embodiments of the disclosure is shown. In many embodiments, the process 800 may be performed by a network device that may be a transmitting network device. The transmitting network device may include a transmission circuitry configured to transmit data to a receiving network device over a communication link. The communication link may be an Ethernet connection. The data may include a calibration sequence, a preamble sequence, and/or a payload sequence. The transmitting network device may be equipped with a power management logic for a periodic calibration of the receiving network device. In many embodiments, the process 800 may monitor the transmission circuitry (block 810). The transmission circuitry may be monitored for any incoming data from a PCS layer, based on which the transmission circuitry may be in a power-down state or a power-up state. In various embodiments, monitoring the transmission circuitry may include observing signal activity on one or more data lanes of the transmission circuitry, tracking clock signal presence or stability of the transmission circuitry, monitoring control or status registers of the transmission circuitry, or evaluating energy usage patterns to infer operational state of the transmission circuitry.

In additional embodiments, the process 800 may detect a power state of the transmission circuitry (block 820). In yet various embodiments, detecting the power state of the transmission circuitry may involve reading internal state indicators or flags, voltage levels on supply rails of the transmission circuitry, or low-level handshake signals exchanged between the PCS layer and the transmission circuitry. The process 800 may determine the power state (e.g., active, sleep, deep power-down, or the like) based on a combination of hardware signals and firmware status indicators associated with the transmission circuitry. For example, if there is no incoming data from the PCS layer for a pre-determined interval of time, the transmission circuitry may be detected to be in a power-down state. However, if the PCS layer is sending data, the transmission circuitry may be in a power-up state. Accordingly, the process 800 may detect that the transmission circuitry is in the power-up state. In the power-up state, the transmission circuitry may transmit the data from the PCS layer to the receiving network device via the communication link. Irrespective of the power state of the transmission circuitry, the process 800 may calibrate the receiving network device so that the receiving network device is synchronized with the transmitting network device.

In a number of embodiments, the process 800 may generate a calibration sequence (block 830). In more embodiments, the calibration sequence may include a calibration identifier and calibration data. The calibration identifier may be configured to precede the calibration data in the calibration sequence. In yet more embodiments, the calibration sequence may be configured for digital calibration or an analog calibration at the receiving network device. In case the calibration sequence is configured for digital calibration at the receiving network device, the calibration sequence may be preceded by the calibration identifier that includes one or more first identifier bits. In case the calibration sequence is configured for analog calibration at the receiving network device, the calibration sequence may be preceded by the calibration identifier that includes one or more second identifier bits different from the one or more first identifier bits.

In a variety of embodiments, the process 800 may transmit the calibration sequence (block 840). In still more embodiments, the process 800 may transmit the calibration sequence periodically. In other words, the process 800 may transmit the calibration sequence at a periodic time instance of a plurality of periodic time instances irrespective of whether the transmission circuitry is in a power-down state or a power-up state to maintain synchronization between the receiving network device and the transmitting network device at all times. The process 800 may maintain link integrity and readiness of the receiving network device even when the transmitting network device is not actively sending payload data. In scenarios where the transmitting network device powers down to save energy, periodic transmission of the calibration sequence may still be executed at scheduled periodic time instances. Thus, when the transmitting network device powers back up, the receiving network device is already calibrated and prepared for immediate and accurate data reception, minimizing link initialization delay and avoiding synchronization issues.

Although a specific embodiment for calibrating a receiving network device suitable for carrying out the various steps, processes, methods, and operations described herein is discussed with respect to FIG. 8, any of a variety of systems and/or processes may be utilized in accordance with embodiments of the disclosure. For example, in case a periodic time instance of a plurality of periodic time instances for calibration occurs amidst an ongoing data transmission by the transmission circuitry, the process 800 may delay the periodic time instance. Based on the delayed periodic time instance, the process 800 transmit the calibration sequence after the ongoing data transmission is complete. The elements depicted in FIG. 8 may also be interchangeable with other elements of FIG. 1-7 and FIG. 9-13 as required to realize a particularly desired embodiment.

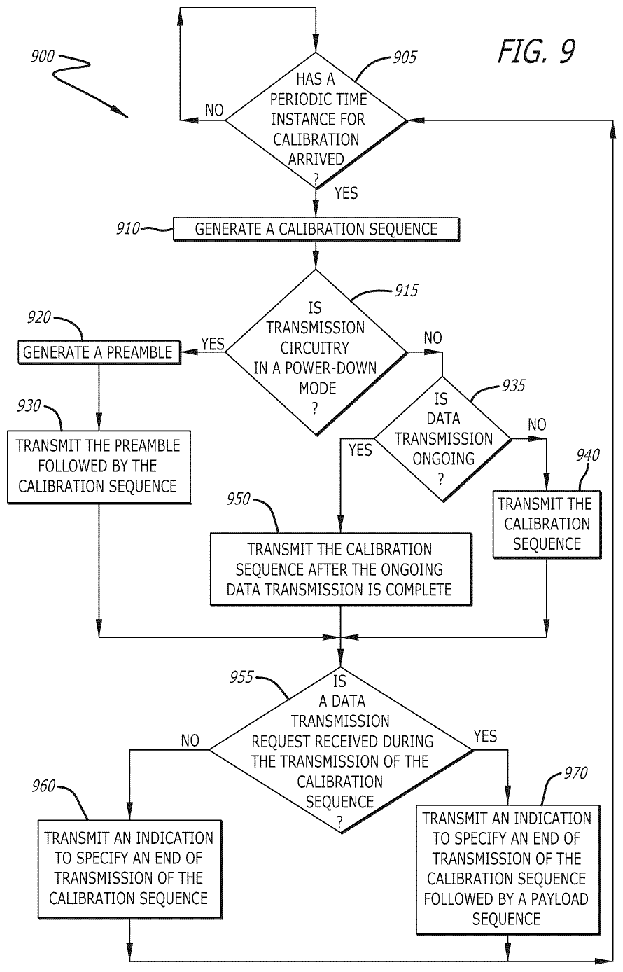

Referring to FIG. 9, a flowchart depicting a process 900 for performing periodic calibration in accordance with various embodiments of the disclosure is shown. In many embodiments, the process 900 may be performed by a transmitting network device. The transmitting network device may be connected to a receiving network device via a communication link, which may be an Ethernet connection. The transmitting network device may include a power management logic configured to manage a periodic calibration of the receiving network device. In additional embodiments, the process 900 may determine whether a periodic time instance for calibration has arrived (block 905). For example, the process 900 may compare a current timestamp with a predefined calibration schedule, checking for elapsed time since a previous calibration event, or evaluating device conditions (e.g., temperature drift, voltage variation, or error rate metrics) that may trigger time-based recalibration. In more embodiments, calibration timing may be based on a programmable timer, calibration signal, or a maintenance interval defined by the power management logic, firmware, or a system policy of the transmitting network device. In such embodiments, the process 900 may determine whether the periodic time instance for calibration has arrived or not by monitoring the programmable timer, a state of the calibration signal, or the like. If the periodic time instance has not arrived, the process 900 may continue monitoring for arrival of the periodic time instance of the plurality of periodic time instances (block 905).

If the periodic time instance has arrived, in numerous embodiments, the process 900 may generate a calibration sequence (block 910). The calibration sequence may be configured to adjust and optimize the receiving network device or one or more link parameters of the receiving network device as well as the communication link. In various embodiments, the calibration sequence may include a calibration identifier and calibration data. The calibration identifier may precede the calibration data in the calibration sequence. Based on the calibration identifier, the receiving network device may be able to differentiate between the calibration data and other data types.

In a variety of embodiments, the process 900 may determine whether the transmission circuitry is in a power-down state (block 915). If the transmission circuitry has not received incoming data from a PCS layer for a pre-determined time interval, the transmission circuitry may be determined to in a power-down state. In yet various embodiments, the process 900 may determine whether the transmission circuitry is in the power-down state by reading internal state indicators or flags, voltage levels on supply rails of the transmission circuitry, or low-level handshake signals exchanged between the PCS layer and the transmission circuitry.

In additional embodiments, if the process 900 determines that the transmission circuitry is in a power-down state, the process 900 may generate a preamble (block 920). The preamble (or preamble sequence) may be configured to wake the receiving network device from the power-down state to a power-up state. The preamble may include a CDR lock pattern and at least one start identifier bit. The CDR lock pattern may refer to a clock pattern or C8 pattern configured to synchronize an internal clock of the receiving network device with an incoming data. Meanwhile, the start identifier bit may be configured to separate the preamble from next input sequence so that the receiving network device may identify the beginning of the next input sequence.

In further embodiments, the process 900 may transmit the preamble followed by the calibration sequence (block 930). The transmission of the preamble may precede the transmission of the calibration sequence to prepare the receiving network device for proper interpretation of the upcoming calibration data. The preamble may help the receiving network device achieve initial synchronization, perform clock and data recovery and stabilize its internal circuitry before the calibration sequence begins. By establishing timing and alignment ahead of calibration, the preamble may ensure that the calibration data is accurately received and processed.

In more embodiments, the process 900 may determine whether a data transmission request is received during the transmission of the calibration sequence (block 955). In other words, the process 900 may keep monitoring for incoming data to be transmitted. The process 900 may involve monitoring of one or more data buffers or one or more data queues associated with the PCS layer while the calibration sequence is being transmitted to detect if the incoming data needs to be transmitted. If a data transmission request arrives during calibration, the process 900 may decide whether to pause, interrupt, or complete the ongoing calibration before switching to payload transmission. Failing to detect such a data transmission request in time may lead to delayed data delivery, increased buffering, or even service interruption if the calibration runs longer than expected.

If the process 900 does not receive a data transmission request during the transmission of the calibration sequence, in yet more embodiments, the process 900 may transmit an indication to specify an end of transmission of the calibration sequence (block 960). The calibration sequence may be transmitted for a predetermined time duration defined by the timing requirements associated with the receiving network device. The calibration sequence may be transmitted for calibrating a digital section or an analog section of the receiving network device. The pre-determined time duration for calibrating the analog section may be longer than the pre-determined time duration for calibrating the digital section of the receiving network device. After the completion of pre-determined time duration, the process 900 may transmit the indication that specifies the end of transmission of the calibration sequence. Such an indication may signal the receiving network device to return to power-down state.

However, if the process 900 receives a data transmission request during the transmission of the calibration sequence, in still yet more embodiments, the process 900 may transmit an indication to specify an end of transmission of the calibration sequence followed by a payload sequence (block 970). Thus, when the process 900 receives the data transmission request before the pre-determined time duration for calibration has ended, the process 900 may immediately end the transmission of the calibration sequence and switch to payload transmission. Accordingly, the receiving network device may receive the indication that the transmission of the calibration sequence is ended, followed by the payload sequence. The process 900 may again check if a next periodic time instance for calibration has arrived (block 905).

However, if the transmission circuitry is already in a power-up state when the periodic time instance for calibration arrives, in still further embodiments, the process 900 may determine whether data transmission is ongoing (block 935). The process 900 may check for ongoing data transmission activity at the periodic time instance. In various embodiments, the process 900 may monitor one or more traffic counters, data buffers, or data queues for data transmission activity. The process 900 can also monitor signal transitions on one or more output lanes of the transmission circuitry or evaluate protocol-level handshakes that indicate active data transmission. In further embodiments, the process 900 may analyse packet scheduling queues or observe whether the PCS layer is asserting valid data frames toward the transmission circuitry to determine whether data transmission is ongoing.

If there is no ongoing data transmission, in yet more embodiments, the process 900 may transmit the calibration sequence (block 940). In other words, if at the periodic time instance for calibration, the transmission circuitry is already in the power-up state and is not transmitting payload data or other control data, the process 900 may transmit the calibration sequence to calibrate the digital section or the analog section of the receiving network device. Based on the calibration identifier, the process 900 may calibrate either the digital section or the analog section of the receiving network device.

However, if there is an ongoing data transmission during at the periodic time instance for calibration, in several embodiments, the process 900 may transmit the calibration sequence after the ongoing data transmission is complete (block 950). Accordingly, the process 900 may delay calibration to a time instance such that the data transmission is completed by that time instance. Once the data transmission is completed, the process 900 may transmit the calibration sequence at the delayed time instance to calibrate the digital section or the analog section of the receiving network device. While transmitting the calibration sequence, the process 900 may check whether a data transmission request is received during the transmission of the calibration sequence (block 955).

Although a specific embodiment for performing a periodic calibration suitable for carrying out the various steps, processes, methods, and operations described herein is discussed with respect to FIG. 9, any of a variety of systems and/or processes may be utilized in accordance with embodiments of the disclosure. For example, the process 900 may assign delay periods to the transmission of the calibration sequence based on real-time network conditions. The elements depicted in FIG. 9 may also be interchangeable with other elements of FIG. 1-8 and FIG. 10-13 as required to realize a particularly desired embodiment.

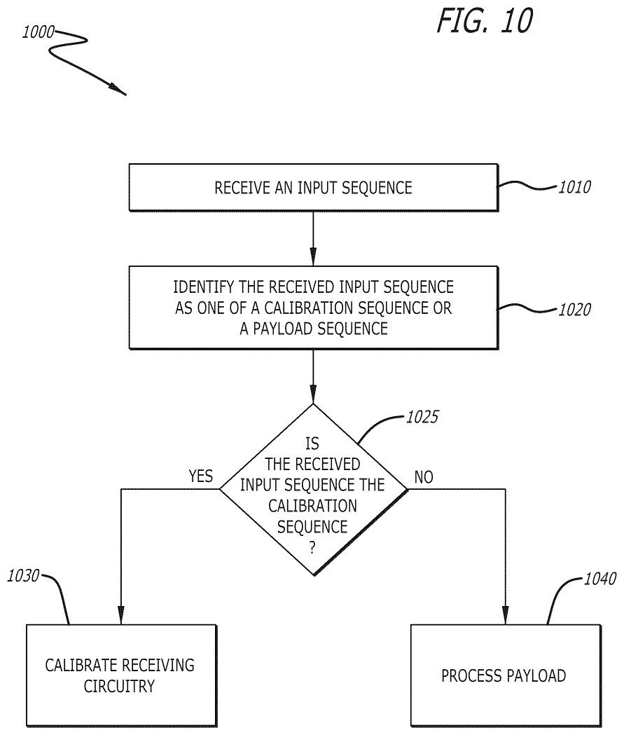

Referring to FIG. 10, a flowchart depicting a process 1000 for calibrating a receiving network device in accordance with various embodiments of the disclosure is shown. In many embodiments, the process 1000 may be performed by the receiving network device. The receiving network device may be coupled with a transmitting network device via a communication link. The connection between the transmitting network device and the receiving network device may be an Ethernet connection. The receiving network device may include a receiving circuitry configured to receive and process data received from the transmitting network device over the communication link. The receiving network device may be equipped with a power management logic for managing a periodic calibration of the receiving network device. In many embodiments, the process may receive an input sequence (block 1010). The input sequence may include a transmission identifier and data with the transmission identifier preceding the data.

In additional embodiments, the process 1000 may identify the received input sequence as one of a calibration sequence or a payload sequence (block 1020). As the received input sequence includes the transmission identifier, the process 900 may identify whether the received input sequence is a calibration sequence or a payload sequence. The transmission identifier may include one of a calibration identifier or a data identifier. Therefore, based on the transmission identifier being the calibration identifier or the data identifier, the process 1000 can identify whether the data following the transmission identifier is calibration data or payload data, respectively.

In a number of embodiments, the process 1000 may determine whether the received input sequence is the calibration sequence (block 1025). In other words, the process 1000 may check the transmission identifier and detect whether the transmission identifier corresponds to the calibration identifier. If the process 1000 detects that the transmission identifier corresponds to the calibration identifier, the process 1000 may determine that the received input sequence is the calibration sequence.

Accordingly, in several embodiments, the process 1000 may calibrate the receiving circuitry (block 1030). In various embodiments, the process 1000 may utilize the calibration data in the calibration sequence for calibrating the receiving circuitry. In yet various embodiments, calibrating the receiving circuitry may include adjusting sampling clock phase and timing using CDR techniques, optimizing equalization parameters to compensate for channel loss or distortion, or tuning offset and gain of input amplifiers, of the receiving circuitry. In more embodiments, calibrating the receiving circuitry may include aligning bit boundaries through bit alignment, calibrating decision threshold levels for comparators of the receiving circuitry, or training link parameters of the communication link. Calibration may also include periodic re-evaluation to account for voltage, temperature, and process variations in the receiving circuitry over time. In many examples, calibrating the receiving circuitry may include calibrating a digital section of the receiving circuitry. In further examples, calibrating the receiving circuitry may include calibrating an analog section of the receiving circuitry.

However, if the process 1000 determines that the received input sequence is not the calibration sequence, the process 1000 may instead determine that the received input sequence is a payload sequence including payload data. In several embodiments, the process 1000 may process the payload data (block 1040). Processing of the payload data may include handling actual user or application-specific information transmitted over the communication link, following a successful link initialization and calibration. The processing of payload data may further involve accurate sampling, decoding, and error correction to recover the original information reliably.

Although a specific embodiment for calibrating a receiving network device suitable for carrying out the various steps, processes, methods, and operations described herein is discussed with respect to FIG. 10, any of a variety of systems and/or processes may be utilized in accordance with embodiments of the disclosure. For example, the transmission identifier may include one or more reserved bits that indicate special types of data or control information that extend a functionality of the Ethernet protocol without interfering with the standard operation. The elements depicted in FIG. 10 may also be interchangeable with other elements of FIG. 1-9 and FIG. 11-13 as required to realize a particularly desired embodiment.

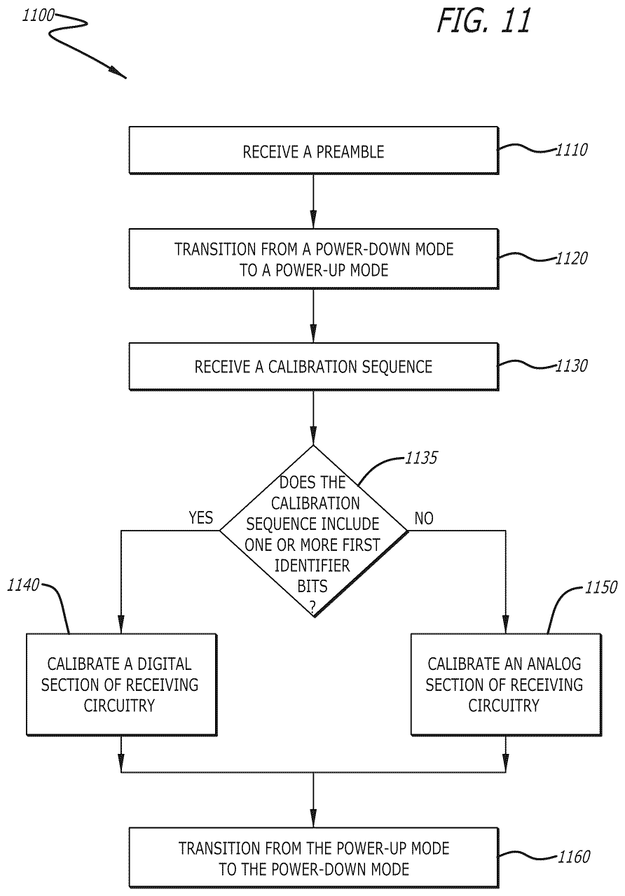

Referring to FIG. 11, a flowchart depicting a process 1100 for power state transition in a receiving network device in accordance with various embodiments of the disclosure is shown. In many embodiments, the process 1100 may be performed at a receiving network device communicatively coupled to a transmitting network device over a communication link. The communication link may support Ethernet protocols and may act as an Ethernet connection. The receiving network device may further include a receiving circuitry configured for receiving and processing data received from the transmitter network device. The receiving network device may be further equipped with a power management logic for managing a power state transition along with handling periodic calibration of the receiving circuitry. In many embodiments, the process 1100 may receive a preamble (block 1110). The preamble (e.g., a preamble sequence) may refer to a preparatory segment transmitted ahead of a calibration sequence to enable the receiving network device to establish synchronization, perform clock and data recovery, and identify the start of valid data. The preamble may include a CDR lock pattern and at least one start identifier bit. The preamble may be configured to wake the receiving circuitry from a power-down state to a power-up state.

In additional embodiments, the process 1100 may transition from a power-down state to a power-up state (block 1120). For example, the process 1100 may perform a power-up sequence to transition the receiving circuitry to the power-up state, thereby enabling the receiving circuitry to process incoming data. In an example, the power-up sequence may include enabling supply voltages, activating clock sources, resetting logic blocks to known states, and initializing internal calibration parameters. In further examples, the process 1100 may also re-establish communication with upstream or downstream logic (e.g., PCS or MAC layers) of the receiving circuitry to detect and decode incoming data reliably.

In a number of embodiments, the process 1100 may receive a calibration sequence (block 1130). Once the preamble is received and processed, the process 1100 may receive the calibration sequence. The calibration sequence may include a calibration identifier and calibration data. The calibration identifier may be configured to precede the calibration data in the calibration sequence. The calibration identifier may correspond to either one or more first identifier bits or one or more second identifier bits.

In a variety of embodiments, the process 1100 may determine whether the calibration sequence includes the one or more first identifier bits (block 1135). The one or more first identifier bits may be different from the one or more second identifier bits. Presence of the one or more first identifier bits in the calibration sequence may indicate calibration of a digital section of the receiving circuitry. However, presence of the one or more second identifier bits in the calibration sequence may correspond to calibration of an analog section of the receiving circuitry.

Thus, if the calibration sequence includes the one or more first identifier bits, in further additional embodiments, the process 1100 may calibrate the digital section of the receiving circuitry (block 1140). Calibrating the digital section of the receiving circuitry may involve adjusting one or more threshold levels for a plurality of decision circuits, synchronizing de-serializer circuits for proper bit and word alignment, or fine-tuning digital equalizers or filters to compensate for channel impairments. Clock and data recovery may also be digitally calibrated to lock onto a timing of an incoming signal.

However, if the calibration sequence includes the one or more second identifier bits, in additional embodiments, the process 1100 may calibrate the analog section of receiving circuitry (block 1150). Calibrating the analog section of the receiving circuitry may include tuning physical components such as amplifiers, filters, or PLLs that may be sensitive to environmental variations such as temperature, voltage, or aging. Calibrating the analog section may further involve adjusting gain in LNAs, correcting offset voltages, or tuning analog filter bandwidths to ensure proper signal fidelity. Unlike digital calibration, analog calibration may require longer settling times and more iterative adjustments due to the continuous nature of analog signals. As a result, analog calibration may be slower than digital calibration.

Once the calibration (e.g., the digital calibration or the analog calibration) is over, the process 1100 may check for incoming payload sequence from the transmitting network device. If there is no incoming payload sequence, in numerous embodiments, the process 1100 may transition from the power-up state to the power-down state (block 1160). That is to say, the receiving circuitry may transition from an active high-power or operational state (the power-up state) to a power-down, low-power, or idle state (the power-down state).

Although a specific embodiment for power state transition in a receiving network device suitable for carrying out the various steps, processes, methods, and operations described herein is discussed with respect to FIG. 11, any of a variety of systems and/or processes may be utilized in accordance with embodiments of the disclosure. For example, if power state transition is simultaneously required in a plurality of receiving circuitries for calibrating the plurality of receiving circuitries, the process 1100 may stagger the power state transition and the subsequent calibration of each of the plurality of receiving circuitries by a pre-determined delay period. The elements depicted in FIG. 11 may also be interchangeable with other elements of FIG. 1-10, 12 and 13 as required to realize a particularly desired embodiment.

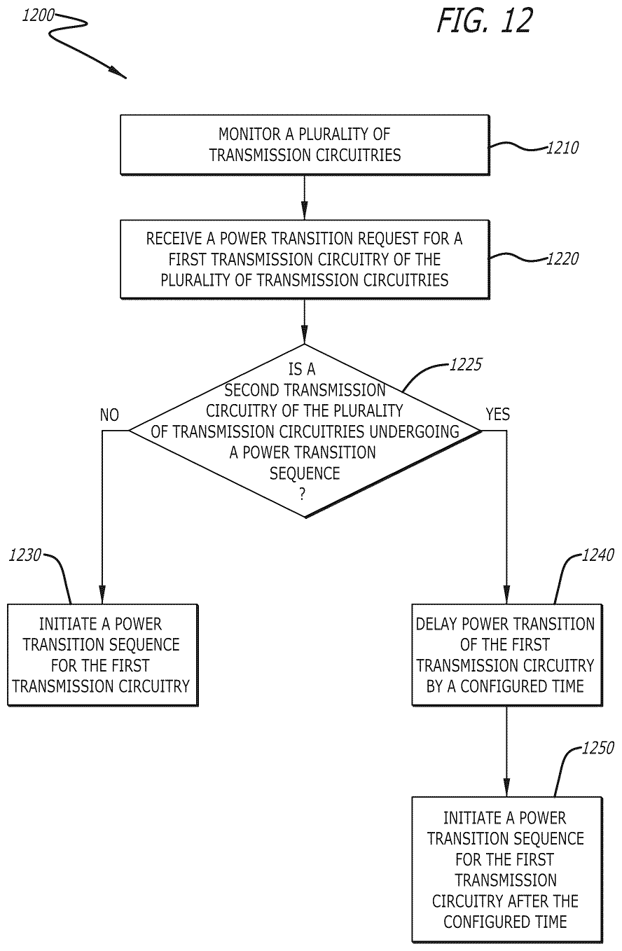

Referring to FIG. 12, a flowchart depicting a process 1200 for assigning delays in accordance with various embodiments of the disclosure is shown. In many embodiments, the process 1200 may be performed at a transmitting network device communicatively coupled to a receiving network device over a communication link. The communication link may support Ethernet protocols and act as an Ethernet connection between the transmitting network device and the receiving network device. The transmitting network device may include a plurality of transmission circuitries configured for processing and transmitting data to the receiving network device. The transmitting network device may be further equipped with a power management logic and a timing controller for managing power state transitions of the plurality of transmission circuitries along with handling periodic calibration of the receiving network device. In many embodiments, the process 1200 may monitor the plurality of transmission circuitries (block 1210). Accordingly, the process 1200 may monitor the plurality of transmission circuitries for any incoming data or lack of incoming data for a predetermined time period that would lead to a power state transition of the plurality of transmission circuitries.

In additional embodiments, the process 1200 may receive a power transition request for a first transmission circuitry of the plurality of transmission circuitries (block 1220). If there is no incoming data for the predetermined time period in a power-up state of the first transmission circuitry, the first transmission circuitry of the plurality of transmission circuitries may send a power transition request for transitioning from the power-up state to a power-down state. Likewise, if there is incoming data in the power-down state of the first transmission circuitry, the first transmission circuitry of the plurality of transmission circuitries may send a power transition request for transitioning from the power-down state to the power-up state to start transmitting the incoming data.

In a number of embodiments, the process 1200 may determine whether a second transmission circuitry of the plurality of transmission circuitries is undergoing a power transition sequence (block 1225). That is to say, the process 1200 may determine if the second transmission circuitry of the plurality of transmission circuitries is undergoing a power transition sequence concurrently at the time when the first transmission circuitry has requested to transition its power state. For example, if there is no incoming data for the predetermined time period in the power-up state of the second transmission circuitry, the second transmission circuitry of the plurality of transmission circuitries may transition from the power-up state to the power-down state concurrently at the same time as the first transmission circuitry may request for the power-down transition. Likewise, if there is incoming data in the power-down state of the second transmission circuitry, the second transmission circuitry of the plurality of transmission circuitries may transition from the power-down state to the power-up state to start transmitting the incoming data simultaneously at the same time as the first transmission circuitry may send a request to transition to the power-up state.

If the second transmission circuitry of the plurality of transmission circuitries is not undergoing a power transition sequence, in a variety of embodiments, the process 1200 may initiate a power transition sequence for the first transmission circuitry (block 1230). That is to say, if there is no incoming data for the predetermined time period in the power-up state of the first transmission circuitry, the first transmission circuitry may start its power-down sequence and start transitioning from the power-up state to the power-down state. The power-down sequence may include halting of the PCS, FEC encoder, and signaling the receiving network device about a last data transmission to maintain the same power state with the receiving network device. Likewise, if there is incoming data in the power-down state of the first transmission circuitry, the first transmission circuitry may begin its power-up sequence and start transitioning from the power-down state to the power-up state to start transmitting the incoming data. The power-up sequence may include reactivating the PCS, the FEC encoder, and signaling the receiving network device to wake up.

However, if the second transmission circuitry of the plurality of transmission circuitries is undergoing a power transition sequence, in further additional embodiments, the process 1200 may delay power transition of the first transmission circuitry by a configured time (block 1240). Assigning the delay for the configured time may refer to deliberately introducing a controlled waiting period for the first transmission circuitry to delay its power state transition and stagger it over the configured time such that the second transmission circuitry performs its power state transition before the first transmission circuitry. The delay for the configured time may enable the process 1200 to prevent any sudden surge or dip in power that may be harmful to the transmitting network device.

In additional embodiments, the process 1200 may initiate a power transition sequence for the first transmission circuitry after the configured time (block 1250). Thus, the power transition of the first transmission circuitry is staggered to a configured time delay. The power transition sequence may thus include sequentially transitioning the corresponding power state of the first transmission circuitry after the configured time delay. For example, the first transmission circuitry may transition its corresponding power state at the end of the configured time after the completion of the power transition sequence of the second transmission circuitry. If prior to transition, the corresponding power state of the first transmission circuitry or the second transmission circuitry is a power-up state, after the transition, the corresponding power state transitions to a power-down state. Similarly, if prior to transition, the corresponding power state of the first transmission circuitry or the second transmission is a power-down state, after the transition, the corresponding power state transitions to the power-up state.

Although a specific embodiment for assigning delays suitable for carrying out the various steps, processes, methods, and operations described herein is discussed with respect to FIG. 12, any of a variety of systems and/or processes may be utilized in accordance with embodiments of the disclosure. For example, if power state transition is simultaneously required in a plurality of receiving circuitries for calibrating the plurality of receiving circuitries, the process 1200 may stagger the power state transition and the subsequent calibration of each of the plurality of receiving circuitries with a configured delay period. The elements depicted in FIG. 12 may also be interchangeable with other elements of FIG. 1-10, 12 and 13 as required to realize a particularly desired embodiment.

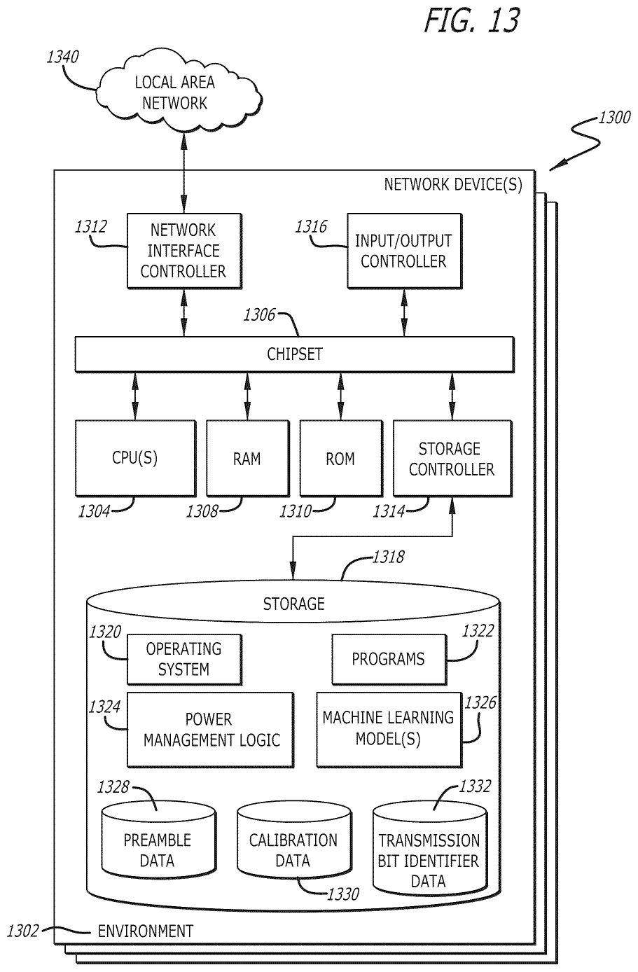

Referring to FIG. 13, a conceptual block diagram of a device 1300 suitable for configuration with a power management logic in accordance with various embodiments of the disclosure is shown. The embodiment of the conceptual block diagram depicted in FIG. 13 can illustrate a conventional server, switch, wireless LAN controller, AP, computer, workstation, desktop computer, laptop, tablet, network appliance, e-reader, smartphone, or other computing device, an ethernet interface, and can be utilized to execute any of the application and/or logic components presented herein. The embodiment of the conceptual block diagram depicted in FIG. 13 can also illustrate an AP, a switch, an edge node, an ethernet interface, or a router in accordance with various embodiments of the disclosure. The device 1300 may, in many non-limiting examples, correspond to physical devices or virtual resources described herein.

In many embodiments, the device 1300 may include an environment 1302 such as a baseboard or “motherboard,” in physical embodiments that can be configured as a printed circuit board with a multitude of components or devices connected by way of a system bus or other electrical communication paths. Conceptually, in virtualized embodiments, the environment 1302 may be a virtual environment that encompasses and executes the remaining components and resources of the device 1300. In more embodiments, one or more processors 1304, such as, but not limited to, central processing units (“CPUs”) can be configured to operate in conjunction with a chipset 1306. The processor(s) 1304 can be standard programmable CPUs that perform arithmetic and logical operations necessary for the operation of the device 1300. In a number of embodiments, the processor(s) 1304 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1306 may provide an interface between the processor(s) 1304 and the remainder of the components and devices within the environment 1302. The chipset 1306 can provide an interface to a random-access memory (“RAM”) 1308, which can be used as the main memory in the device 1300 in some embodiments. The chipset 1306 can further be configured to provide an interface to a computer-readable storage medium such as a read-only memory (“ROM”) 1310 or non-volatile RAM (“NVRAM”) for storing basic routines that can help with various tasks such as, but not limited to, starting up the device 1300 and/or transferring information between the various components and devices. The ROM 1310 or NVRAM can also store other application components necessary for the operation of the device 1300 in accordance with various embodiments described herein.

Additional embodiments of the device 1300 can be configured to operate in a networked environment using logical connections to remote computing devices and computer systems through a network, such as the network 1340. The chipset 1306 can include functionality for providing network connectivity through a network interface card (“NIC”) 1312, which may comprise a gigabit Ethernet adapter or similar component. The NIC 1312 can be capable of connecting the device 1300 to other devices over the network 1340. It is contemplated that multiple NICs 1312 may be present in the device 1300, connecting the device to other types of networks and remote systems.

In further embodiments, the device 1300 can be connected to a storage 1318 that provides non-volatile storage for data accessible by the device 1300. The storage 1318 can, for instance, store an operating system 1320 and programs 1322 (e.g., applications). The storage 1318 can be connected to the environment 1302 through a storage controller 1314 connected to the chipset 1306. In various other embodiments, the storage 1318 can consist of one or more physical storage units. The storage controller 1314 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1300 can store data within the storage 1318 by transforming the physical state of the physical storage units to reflect the information being stored. The specific transformation of physical state can depend on various factors. Examples of such factors can include, but are not limited to, the technology used to implement the physical storage units, whether the storage 1318 is characterized as primary or secondary storage, and the like.

In many more embodiments, the device 1300 can store information within the storage 1318 by issuing instructions through the storage controller 1314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1300 can further read or access information from the storage 1318 by detecting the physical states or characteristics of one or more particular locations within the physical storage units.

In addition to the storage 1318 described above, the device 1300 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1300. In some examples, the operations performed by a cloud computing network, or any components included therein, may be supported by one or more devices similar to device 1300. Stated otherwise, some or all of the operations performed by the cloud computing network, and or any components included therein, may be performed by one or more devices 1300 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1318 can store an operating system 1320 utilized to control the operation of the device 1300. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1318 can store other system or application programs and data utilized by the device 1300.

In many additional embodiments, the storage 1318 or other computer-readable storage media is encoded with computer-executable instructions which, when loaded into the device 1300, may transform it from a general-purpose computing system into a special-purpose computer capable of implementing the embodiments described herein. These computer-executable instructions may be stored as programs 1322 (e.g., an application) and transform the device 1300 by specifying how the processor(s) 1304 can transition between states, as described above. In some embodiments, the device 1300 has access to computer-readable storage media storing computer-executable instructions which, when executed by the device 1300, perform the various processes described above with regard to FIGS. 1-12. In certain embodiments, the device 1300 can also include computer-readable storage media having instructions stored thereupon for performing any of the other computer-implemented operations described herein.

In many further embodiments, the device 1300 may include a power management logic 1324. The power management logic 1324 can be configured to perform one or more of the various steps, processes, operations, and/or other methods that are described above. Often, the power management logic 1324 can be a set of instructions stored within a non-volatile memory that, when executed by the processor(s) 1304 can carry out these steps, etc. In some embodiments, the power management logic 1324 may be a client application that resides on a network-connected device, such as, but not limited to, a server, switch, an ethernet interface, personal or mobile computing device in a single or distributed arrangement. The power management logic 1324 may be configured to perform periodic link calibration. The device herein may be a communication port associated with the Ethernet interface.

The power management logic 1324 may be further configured to generate a calibration sequence to calibrate a receiving circuitry of a receiving network device. The calibration sequence may include a calibration identifier and calibration data. The calibration identifier may precede the calibration data in the calibration sequence and transmit the calibration sequence via the transmission circuitry to the receiving network device. The calibration sequence may be configured for calibrating a digital or an analog section of the receiving circuitry. The power management logic may transmit the calibration sequence at a periodic instance of a plurality of periodic instances. In other words, the power management logic 1324 may be configured to calibrate the receiving network device periodically.

The power management logic 1324 may be further configured to stagger power state transition of a plurality of transmission circuitries in the device 1300 if the plurality of transmission circuitries request for power state transition concurrently. Similarly, the power management logic 1324 may stagger power state transition of a plurality of receiving circuitries if the plurality of receiving circuitries simultaneously requires power state transition. Thus, the power management logic 1324 may stagger the power state transition and the subsequent calibration of each of the plurality of receiving circuitries with a configured delay period.

In some embodiments, the storage 1318 can include configured preamble data 1328. The preamble data 1328 may refer to a predefined sequence of bits transmitted at the beginning of a communication burst or packet to prepare a receiving network device for incoming data. The preamble data 1328 may include one or more patterns that enable CDR, symbol alignment, and synchronization. For example, in Ethernet, the preamble can be a C8 pattern (in hexadecimal), where the receiving network device lock onto the signal timing. The preamble data 1328 may also include a start identifier bit to indicate end of the preamble data and start of valid data. The start identifier bit may be a zero-energy pulse signal.

In various embodiments, the storage 1318 can include calibration data 1330. The calibration data 1330 may refer to known, structured bit patterns used to tune or optimize a communication link or the receiving circuitry. The calibration data 1330 may enable equalization, gain control, offset adjustment, or timing alignment in high-speed or burst-mode links. For example, a calibration pattern might be a repetitive sequence like 10101010 or a training sequence defined by the protocol, such as in PCIe or SATA. The calibration data 1330 may allow the receiving network device to adapt its analog and digital settings to the channel conditions before handling real payload data.

In a number of embodiments, the storage 1318 can include transmission bit identifier data 1332. The transmission bit identifier data 1332 may refer to specific bits or bit patterns included within the data stream, generally before a calibration sequence or a payload sequence or any data sequence to signal the type or role of the following data segment, such as whether it is preamble, calibration, control, or payload data. The transmission bit identifier data 1332 may help the receiving network device distinguish between different parts of the communication burst and process them accordingly. In a non-limiting example, a particular bit field may be set to 00 for payload data, 10 for calibration data for calibrating a digital section of the receiving network device, or for a beacon signal, 11 for calibration data for calibrating an analog section of the receiving network device, while 01 may be reserved bits for various other future protocols or data type.

In still further embodiments, the device 1300 can also include one or more input/output controllers 1316 for receiving and processing input from a number of input devices, such as a keyboard, a mouse, a touchpad, a touch screen, an electronic stylus, or other type of input device. Similarly, an input/output controller 1316 can be configured to provide output to a display, such as a computer monitor, a flat panel display, a digital projector, a printer, or other type of output device. Those skilled in the art will recognize that the device 1300 might not include all of the components shown in FIG. 13 and can include other components that are not explicitly shown in FIG. 13 or might utilize an architecture completely different than that shown in FIG. 13.

As described above, the device 1300 may support a virtualization layer, such as one or more virtual resources executing on the device 1300. In some examples, the virtualization layer may be supported by a hypervisor that provides one or more virtual machines running on the device 1300 to perform functions described herein. The virtualization layer may generally support a virtual resource that performs at least a portion of the techniques described herein.

Finally, in numerous additional embodiments, data may be processed into a format usable by a ML model(s) 1326 (e.g., feature vectors), or other pre-processing techniques. The ML model(s) 1326 may be any type of ML model, such as supervised mode, reinforcement model, and/or unsupervised model. The ML model(s) 1326 may include one or more of linear regression model, logistic regression model, decision trees, Naïve Bayes model, neural networks, k-means cluster model, random forest model, and/or other types of ML model(s) 1326. In an example, the ML model(s) 1326 may include the plurality of classifiers, each trained for a specific task such as error correction and encoding or decoding of one or more data frames transmitted before and after power transitioning phase by the device, that share common encoder(s).

The ML model(s) 1326 can be configured to generate inferences to make predictions or draw conclusions from data. An inference can be considered the output of a process of applying a model to new data. This can occur by learning from at least the preamble data 1328, the calibration data 1330, and the transmission bit identifier data 1332. These predictions are based on patterns and relationships discovered within the data. To generate an inference, the trained model can take input data and produce a classification result. The input data can be in various forms, such as images, audio, text, or numerical data, network packet data depending on the type of problem the model was trained to solve. The output of the model can also vary depending on the problem, and can be a single number, a probability distribution, a set of labels, a decision about an action to take, etc. Ground truth for the ML model(s) 1326 may be generated by human/administrator verifications or may compare predicted outcomes with actual outcomes. Further, the ML model(s) 1326 may be configured to process the calibration data 1330 based on the transmission bit identifier data 1332. For example, the ML model(s) 1326 may predict whether the calibration is for calibrating a digital or an analog section of the receiving circuitry of the receiving network device based on the calibration data 1330 being compared with the transmission bit identifier data 1332. By learning from the preamble data 1328 and the calibration data 1330, the ML model(s) 1326 can predict what kind of power transition request may be requested by the device and whether to stagger the power transition request by a configured time delay or grant the power transition request immediately. In other words, once trained, the ML model(s) 1326 may be further deployed on the device 1300 (e.g., a transmitter, a receiver, a remiter, a transceiver, a communication port or the like) for power control management in the Ethernet interface.

Although a specific embodiment for a device suitable for configuration with the power management logic for carrying out the various steps, processes, methods, and operations described herein is discussed with respect to FIG. 13, any of a variety of systems and/or processes may be utilized in accordance with embodiments of the disclosure. For example, the device 1300 may be in a virtual environment such as a cloud-based network administration suite, or it may be distributed across a variety of network devices or APs. The elements depicted in FIG. 13 may also be interchangeable with other elements of FIG. 1-12 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the scope of the present disclosure, as set forth in the appended claims, as might be apparent to those of ordinary skill in the art, are also encompassed by the present disclosure.

What is claimed is:

1. A transmitting network device, comprising:
a transmission circuitry communicatively coupled to a receiving network device over a communication link; and
a power management logic coupled to the transmission circuitry, wherein the power management logic is configured to:
generate a calibration sequence, wherein:
the calibration sequence comprises a calibration identifier and calibration data, and
the calibration identifier precedes the calibration data in the calibration sequence; and
transmit the calibration sequence via the transmission circuitry to the receiving network device.

2. The transmitting network device of claim 1, wherein the power management logic is further configured to:
generate a preamble sequence; and
transmit the preamble sequence via the transmission circuitry to the receiving network device.

3. The transmitting network device of claim 2, wherein the preamble sequence is configured to wake the receiving network device from a power-down state to a power-up state.

4. The transmitting network device of claim 2, wherein the transmission of the preamble sequence precedes the transmission of the calibration sequence.

5. The transmitting network device of claim 2, wherein the preamble sequence comprises a Clock and Data Recovery (CDR) lock pattern and at least one start identifier bit.

6. The transmitting network device of claim 1, wherein the power management logic is further configured to transmit the calibration sequence at a periodic time instance of a plurality of periodic time instances.

7. The transmitting network device of claim 1, wherein the calibration sequence is configured for digital calibration at the receiving network device.

8. The transmitting network device of claim 1, wherein the calibration sequence is configured for analog calibration at the receiving network device.

9. The transmitting network device of claim 1, wherein in a case where a periodic time instance of a plurality of periodic time instances for calibration occurs amidst an ongoing data transmission by the transmission circuitry, the power management logic is further configured to:
delay the periodic time instance; and
transmit the calibration sequence after the ongoing data transmission is complete based on the delayed periodic time instance.

10. The transmitting network device of claim 1, wherein the power management logic is further configured to:
receive a data transmission request during the transmission of the calibration sequence;
transmit, via the transmission circuitry, an indication to specify an end of the calibration sequence in response to receiving the data transmission request; and
transmit a payload sequence associated with the data transmission request after the indication.

11. The transmitting network device of claim 10, wherein:
the payload sequence comprises a data identifier and payload data, and
the data identifier precedes the payload data in the payload sequence.

12. The transmitting network device of claim 1, wherein the calibration identifier comprises one of:
one or more first identifier bits in a case where the calibration sequence is configured for digital calibration at the receiving network device, or
one or more second identifier bits in a case where the calibration sequence is configured for analog calibration at the receiving network device, wherein the one or more first identifier bits are different from the one or more second identifier bits.

13. The transmitting network device of claim 1, wherein the calibration sequence is configured to indicate that the communication link is active.

14. The transmitting network device of claim 1, wherein the transmission circuitry corresponds to a Serializer/Deserializer transmitter.

15. A receiving network device, comprising:
a receiving circuitry communicatively coupled to a transmitting network device over a communication link; and
a power management logic coupled to the receiving circuitry, wherein the power management logic is configured to:
receive an input sequence comprising a transmission identifier and data over the communication link, wherein the transmission identifier precedes the data; and
identify the received input sequence as one of a calibration sequence or a payload sequence based on the transmission identifier.

16. The receiving network device of claim 15, wherein the power management logic is further configured to calibrate the receiving circuitry based on the identification of the received input sequence as the calibration sequence.

17. The receiving network device of claim 16, wherein the power management logic is further configured to one of:
identify the received input sequence as the calibration sequence based on the transmission identifier comprising one of one or more first identifier bits or one or more second identifier bits, or
identify the received input sequence as the payload sequence based on the transmission identifier comprising one or more third identifier bits.

18. The receiving network device of claim 17, wherein the receiving circuitry comprises a digital section and an analog section, and wherein the power management logic is further configured to one of:
calibrate the digital section based on the identification of the received input sequence as the calibration sequence and the transmission identifier comprising the one or more first identifier bits, or
calibrate the analog section based on the identification of the received input sequence as the calibration sequence and the transmission identifier comprising the one or more second identifier bits.

19. The receiving network device of claim 15, wherein the receiving circuitry is further configured to detect that the communication link is active based on the identification of the received input sequence as the calibration sequence.

20. A method at a transmitting network device, the method comprising:
generating a calibration sequence, wherein:
the calibration sequence comprises a calibration identifier and calibration data, and
the calibration identifier precedes the calibration data in the calibration sequence; and
transmitting, at a periodic time instance of a plurality of periodic time instances, the calibration sequence to a receiving network device.
